(19) United States
(12) Patent Application Publication
(10) Pub. No.: US 2008/0104861 A1
(43) Pub. Date: May 8, 2008

(54) Method for drying coating film, apparatus therefor, and optical film using the same

(75) Inventor: Takashi Yahiro, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minota-ku (JP)

(21) Appl. No.: 11/979,674

(22) Filed: Nov. 7, 2007

(30) Foreign Application Priority Data
Nov. 7, 2006 (JP) 2006-302003

(51) Int. Cl. G03C 1/74; F26B 21/00

(52) U.S. Cl. 34/463; 34/635; 428/212

(57) ABSTRACT

An aspect of the present invention provides a method for drying a coating film that has been formed by applying a coating liquid to a traveling long support, by forming a tunnel-shaped drying zone so as to surround the support, and supplying drying air into the drying zone from a rectangular air-supplying nozzle which faces to the drying zone, wherein the air-supplying nozzle is designed so that among layer components of the drying air which is supplied from the air-supplying nozzle, a boundary layer component which has flowed in the vicinity of the inner wall surface of the air-supplying nozzle and is supplied from the nozzle cannot hit the surface of the coating film, while there are the boundary layer component and a central layer component which has flowed in a central part of the air-supplying nozzle and is supplied from the nozzle, in the layer components.

### BACKGROUND OF THE INVENTION

1. Field of the Invention

The present invention relates to a method for drying a coating film, an apparatus therefor, and an optical film using the same, and particularly relates to a method for drying a coating film which is formed by applying a coating liquid onto a traveling long support (hereafter referred to as web) so that the coating film does not form an unevenness of drying, an apparatus therefor, and an optical film using the same.

2. Description of the Related Art

When drying a coating film formed by applying a coating liquid containing an organic solvent onto a continuously traveling support, drying air is usually supplied and exhausted so as to promote drying. However, the method has a problem of forming an unevenness of drying (for instance, streak defect due to the unevenness of film thickness) on the surface of the coating film after having been dried, because a supplied and exhausted turbulent drying air directly hits the surface of the coating film, and makes the surface of the coating film flow.

The unevenness of drying may become a critical defect for an optical performance, particularly when a coating film of an optical film to be used in a liquid crystal display (for instance, optical compensation film, antireflection film and anti-glare film) is dried.

Several methods are proposed as measures of inhibiting such an unevenness of drying. One is a method of straightening drying air with the use of a perforated plate (Japanese Examined Application Publication No. H02-58554). Another one is a method of producing drying air which flows in one-direction from one end to the other end in a width direction of a support (Japanese Patent Application Laid-Open No. 2001-170547 and Japanese Patent Application Laid-Open No. 2005-81257). Thereby, the methods prevent the turbulent drying air from directly hitting the surface of the coating film.

In addition, a method for inhibiting the unevenness of drying in a width direction is proposed (for instance, Japanese Patent Application Laid-Open No. 2005-114188) which includes arranging a gas supply box and a gas exhaust box at positions which oppose to a coating film, uniformly blowing a gas onto the coating film in the width of the coating film, and then exhausting the gas in the width of the coating film.

### SUMMARY OF THE INVENTION

The methods according to the above described Japanese Examined Application Publication No. H02-58554, Japanese Patent Application Laid-Open No. 2001-170547, Japanese Patent Application Laid-Open No. 2005-81257 and Japanese Patent Application Laid-Open No. 2005-114188 could inhibit the unevenness of drying due to a turbulent airflow to some extent, but have not reached a sufficient level for application fields to which a higher quality is required.

The present invention is designed with respect to the above described circumstances, and is directed at providing a method for drying a coating film, which can prevent the unevenness of drying with high accuracy.

The first aspect according to the present invention for achieving the above described purpose is a method for drying a coating film that has been formed by applying a coating liquid to a traveling long support, by forming a tunnel-shaped drying zone so as to surround the support, and supplying drying air into the drying zone from a rectangular air-supplying nozzle which faces to the drying zone, wherein the air-supplying nozzle is designed so that among layer components of the drying air which is supplied from the air-supplying nozzle, a boundary layer component which has flowed in the vicinity of the inner wall surface of the air-supplying nozzle and is supplied from the nozzle cannot hit the surface of the coating film, while there are the boundary layer component and a central layer component which has flowed in a central part of the air-supplying nozzle and is supplied from the nozzle, in the layer components.

The present inventors made an extensive investigation on a cause of the unevenness of drying, and as a result, have found that the unevenness of drying occurs when the turbulent airflow in the boundary layer (boundary layer component of drying air) directly hits the surface of the coating film, which is formed when the drying air passes through the vicinity of an wall surface in an air-supplying pipeline and the air-supplying nozzle.

The method according to the first aspect supplies air so that the drying air containing the turbulent airflow of the boundary layer formed in the vicinity of the inner wall surface of the air-supplying nozzle does not directly hits the surface of the coating film, and accordingly can prevent the unevenness of drying.

The second aspect is the method for drying the coating film according to the first aspect, wherein the boundary layer component is a drying air component having an air velocity of 66% or less with respect to the air velocity in a center of the air-supplying nozzle.

The third aspect is the method for drying the coating film according to any one of the aspects 1 and 2, wherein an upper inner wall surface and a lower inner wall surface of the air-supplying nozzle are installed so that clearances (Y) between the upper inner wall surface and the surface of the coating film and between the lower inner wall surface and the surface of the coating film can be each 5 mm or more in a vertical direction with respect to the surface of the coating film, for the purpose of inhibiting the boundary layer component from hitting the surface of the coating film, when the air-supplying nozzles are arranged in one side of the support in a width direction so as to blow the drying air from the air-supplying nozzle in parallel to the surface of the coating film.

The method according to the third aspect can prevent the boundary layer component produced on the inner wall surface of the air-supplying nozzle from directly hitting the surface of the coating film, with an easy process.

The fourth aspect is the method for drying the coating film according to the third aspect, wherein a clearance X1 between the air-supplying nozzle and an end of the support in an air-supplying nozzle side in a width direction is 50 mm or more.

The fifth aspect is the method for drying the coating film according to any one of the aspects 1 and 2, wherein the boundary layer component flowing in the vicinity of the inner wall surface of the air-supplying nozzle is sucked and removed so as not to hit the surface of the coating film.

The method according to the fifth aspect removes a turbulent airflow in the boundary layer, which has been formed in the vicinity of the inner wall surface of the air-supplying nozzle, can supply stable drying air to a drying zone, and accordingly can prevent the unevenness of drying.

The sixth aspect is the method for drying the coating film according to the fifth aspect, wherein the amount of air to be sucked and removed from the boundary layer component is in a range of 5 to 20% with respect to the total amount of the air blown from the air-supplying nozzle.

The method according to the sixth aspect can more reliably remove the turbulent airflow of the boundary layer, which has been formed when air passes through the inner wall surface of the air-supplying nozzle, and accordingly can surely inhibit the unevenness of drying.

The seventh aspect according to the present invention for achieving the purpose is an apparatus for drying a coating film that has been formed by applying a coating liquid to a traveling long support, comprising: a tunnel-shaped drying zone surrounding the support; an air-supplying nozzle for supplying drying air to one side of the support in a width direction from the other side in parallel to the surface of the coating film in the drying zone; and a moving device which moves the air-supplying nozzle in a direction perpendicular to the surface of the coating film to change a relative position of the air-supplying nozzle with respect to the surface of the coating film.

The eighth aspect according to the present invention for achieving the purpose is an apparatus for drying a coating film that has been formed by applying a coating liquid to a traveling long support, comprising: a drying zone which surrounds the support in a tunnel shape; a rectangular air-supplying nozzle for supplying drying air into the drying zone; and a suction device which is installed in the air-supplying nozzle, and sucks and removes the drying air that passes the vicinity of the inner wall surface of the air-supplying nozzle.

The seventh aspect and the eighth aspect describe the present invention in a form of an apparatus.

The ninth aspect according to the present invention is an optical film which has been produced with the method for drying the coating film according to any one of aspects 1 to 6.

The optical film described here includes films having various functions, such as an optical compensation film for a liquid crystal display board, an antireflection film and an anti-glare film.

Method and apparatus according to the present invention can prevent an unevenness of drying with high precision.

### BRIEF DESCRIPTION OF THE DRAWINGS

FIG. 1 is an explanatory drawing for describing drying air in an air-supplying nozzle;

FIG. 2 is a sectional view for describing a coating/drying apparatus according to a first embodiment;

FIG. 3 is a sectional view taken along the line A-A in FIG. 1;

FIG. 4 is an explanatory drawing for describing a configuration of air-supplying/air-exhausting nozzles in a drying apparatus in FIG. 1;

FIG. 5 is a sectional view showing a relationship between positions of a web and air-supplying/air-exhausting nozzles in FIG. 3;

FIGS. 6A and 6B are sectional views for describing a drying apparatus according to a second embodiment;

FIG. 7 is a sectional view for describing a drying apparatus according to a third embodiment;

FIG. 8 is an explanatory drawing for describing a drying apparatus according to a fourth embodiment;

FIGS. 9A and 9B are partial sectional views of an air-supplying nozzle in FIG. 7;

FIG. 10 is an explanatory drawing for describing another aspect of a drying apparatus according to the third embodiment;

FIG. 11 is an explanatory drawing for describing another aspect of a drying apparatus according to the third embodiment;

FIG. 12 is an explanatory drawing in the present example; and

FIG. 13 is a view showing a chemical formula of a discotic compound according to the present example.

### DETAILED DESCRIPTION OF THE PREFERRED EMBODIMENTS

Preferred embodiments of a method for drying a coating film according to the present invention will be now described below with reference to the attached drawings.

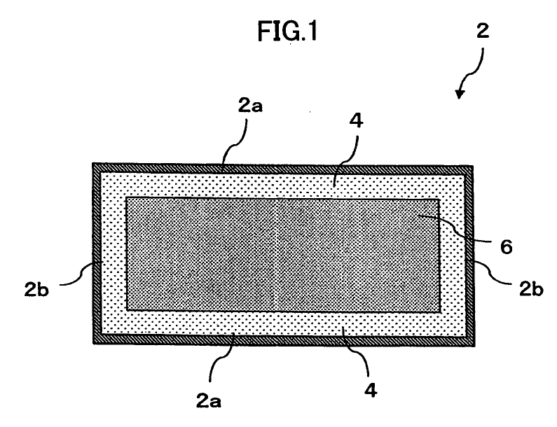

At first, a condition of drying air on an inner wall surface of an air-supplying nozzle will be now described. FIG. 1 is a sectional view for describing the condition of the inner wall surface of the air-supplying nozzle.

As is shown in the figure, the drying air passing through the air-supplying nozzle 2 is mainly composed of a boundary layer component 4 which passes in the vicinity of the inner wall surfaces 2a and 2b of the air-supplying nozzle, and a central layer component 6 which passes in the vicinity of the center distant from the inner wall surfaces 2a and 2b.

The central layer component 6 is a drying air component which is stable and uniform. On the other hand, the boundary layer component 4 has a flow velocity less homogeneous than that in the central layer component 6, and is a drying air component containing a turbulent airflow. Specifically, the boundary layer component 4 is the drying air component having an air velocity of 66% or less with respect to the air velocity in the center of the air-supplying nozzle. The method in the present invention includes supplying the drying air so that the boundary layer component 4 does not directly hit the surface of a coating film. In each embodiment according to the present invention hereafter, it shall be possible to ignore such a part of the boundary layer component 4 as not to almost affect a support face (part which does not directly hit support face), though the part depends on a positional relationship between the support surface and the air-supplying nozzle.

A first embodiment according to the present invention will now be described. A drying method according the present embodiment is the method of supplying air while avoiding a turbulent airflow of a boundary layer (boundary layer component), which has occurred in an air-supplying nozzle, in a drying zone for producing drying air in one direction of a width direction of a support.

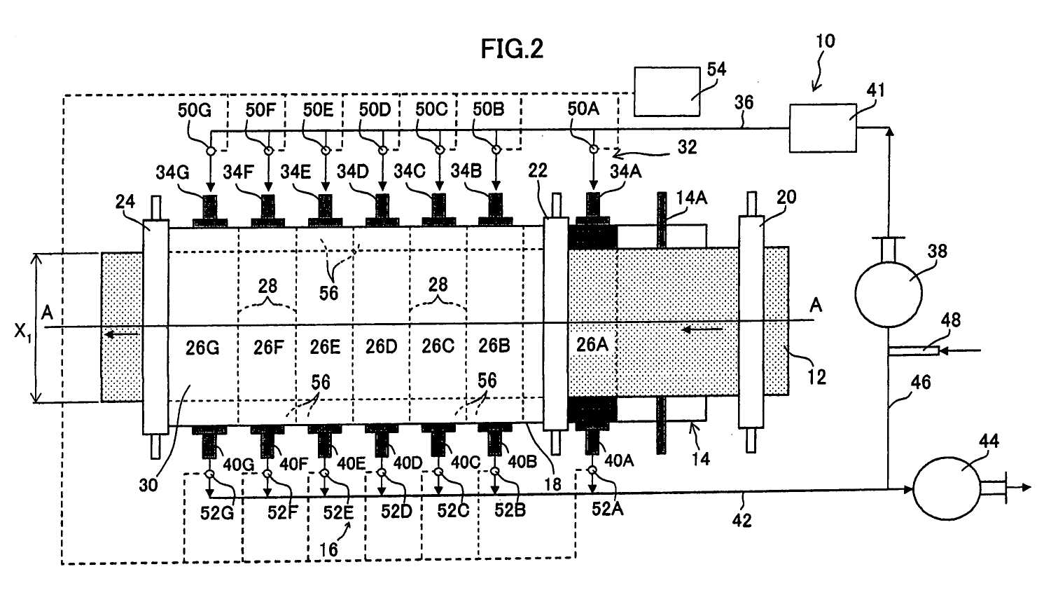

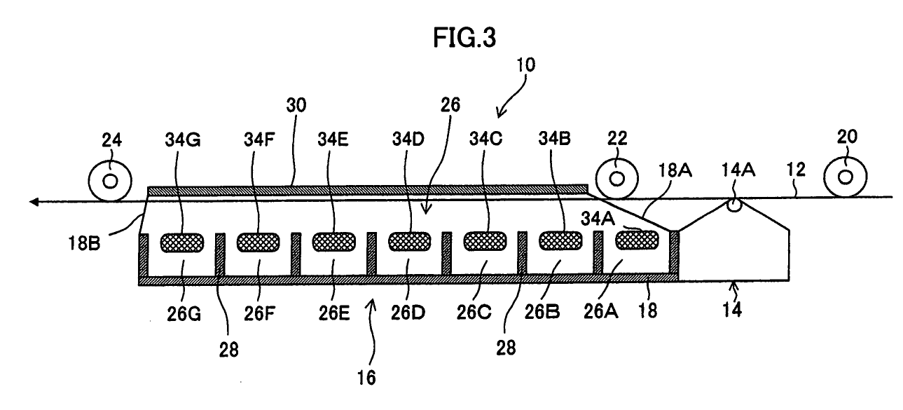

FIG. 2 is a plane view of an apparatus for coating/drying a coating film for conducting a drying method according to the present invention from the upper viewpoint, and FIG. 3 is a sectional view taken along the line A-A in FIG. 2.

As shown in FIG. 2 and FIG. 3, the coating/drying apparatus 10 is mainly composed of an applicator 14 for applying a coating liquid containing an organic solvent onto a traveling long support 12 (hereafter referred to as web 12), and a drying apparatus 16 for drying the coating film while passing the web 12 to which the coating liquid has been applied. In the present embodiment, the drying apparatus 16 is installed right after the applicator 14.

The applicator 14 can employ, for instance, a bar coating device provided with a wire bar 14A, applies the coating liquid to the bottom surface of the web 12 which is supported by a plurality of support rollers 20, 22 and 24 to travel, and thereby forms the coating film. The coating film has a wet thickness in a range of 1 μm to 50 μm, preferably of 2 μm to 40 μm, and further preferably of 2 μm to 10 μm. The viscosity of the coating liquid is preferably 20 mPas/second or less. The web 12 travels at a speed preferably in a range of 5 to 100 m/minute, and in particular preferably of 20 to 80 m/minute.

A drying apparatus 16 is formed into a rectangular box shape and is placed along a coating film surface side (bottom surface side of the web) of a traveling web 12. Among each side of the box, the coating film surface side (upper side of the box) is removed. In addition, a screening lid 30 is installed at an opposing position to a main body 18 of a drying apparatus across the web 12 so as to cover the main body 18, for the purpose of preventing wind such as air-conditioning wind coming from the outside of the drying apparatus 16 from hindering the stable traveling of the web 12. Then, the web 12 to which a coating liquid has been applied by an applicator 14 is carried into a drying zone 26 through an inlet 18A of the drying apparatus 16, and is carried out through an outlet 18B. Thus, the drying zone 26 is formed so as to surround the traveling web 12.

The drying zone 26 is composed of a plurality of divided zones 26A, 26B, 26C, 26D, 26E, 26F and 26G (seven divided zones in the present example) which are formed by partitioning the main body 18 of the drying apparatus with a plurality of partition plates 28 that are installed perpendicular to the traveling direction of the web 12. In this case, a distance between a top edge of the partition plate 28 which divides the drying zone 26 and the surface of the coating film formed on the web 12 is preferably in a range of 0.5 mm to 20 mm, and further preferably of 1 mm to 15 mm.

In addition, a one-direction airflow generation device 32 is installed in the respective divided zones 26A to 26G of the drying zone 26, as is shown in FIG. 2. In the above description, the number of divided drying zones and the number of the one-direction airflow generation devices 32 arranged in one drying zone are not limited to the above described number.

The one-direction airflow generation device 32 is branched and connected to air-supplying nozzles 34A to 34G (air-supplying portions) through an air-supplying duct 36, which are installed on one side out of both sides of the main body 18 of the drying apparatus. An air-supplying fan 38 is installed and connected to the air-supplying duct 36. In addition, air-exhausting nozzles 40A to 40G are installed so as to face the air-supplying nozzles 34A to 34G, in the other side of both sides of the main body 18 of the drying apparatus, and an exhaust duct 42 is branched and connected to the respective air-exhausting nozzles 40A to 40G. An exhaust fan 44 is installed and connected to the exhaust duct 42. A circulation duct 46 is branched from some midpoint of the exhaust duct 42, and is connected to the suction side of the air-supplying fan 38. A duct 48 for introducing new drying air is provided in some midpoint of the circulation duct 46. An air temperature controller 41 for controlling the temperature of the drying air is installed in the air-supplying duct 36 to control the temperature of the drying air which is blown from the air-supplying nozzles 34A to 34G.

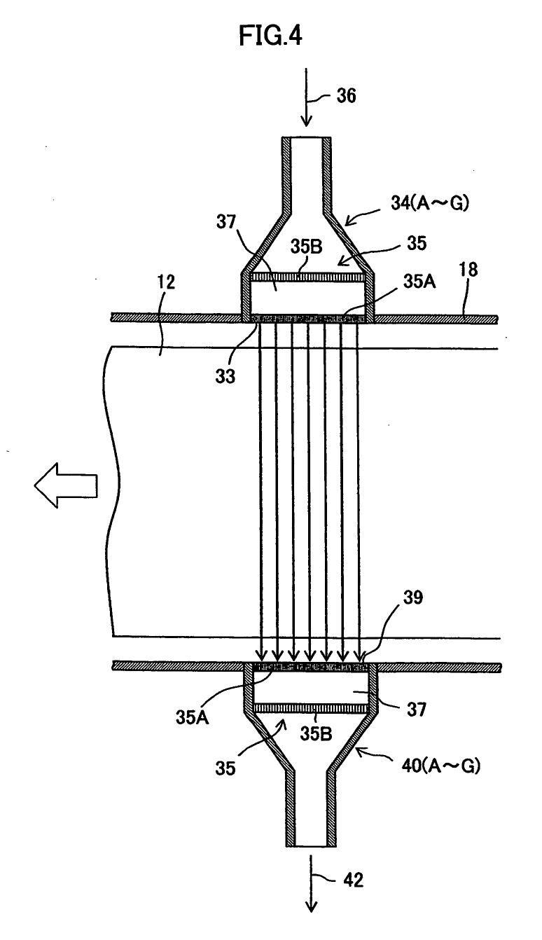

FIG. 4 is an explanatory drawing for describing a configuration of an air-supplying nozzle and an air-exhausting nozzle. As is shown in FIG. 4, the respective air-supplying nozzles 34A to 34G have a supply opening 33 (an air-supplying portion connected to a drying zone), which are formed into an approximately rectangular shape having a longer side in a traveling direction of a web 12, and simultaneously a trumpet shape of which the size increases toward the supply opening 33. In the respective air-supplying nozzles 34A to 34G, straightening vanes 35 are provided. The straightening vane 35 is composed of a first perforated plate 35A installed in the supply opening 33 and a second perforated plate 35B installed in the upstream of the supply opening 33. An opening of a hole of the first perforated plate 35A is formed so as to be smaller than that of the second perforated plate 35B, and a pressure-uniformizing chamber 37 for drying air blown from the supply opening 33 is formed between the first perforated plate 35A and the second perforated plate 35B. On the other hand, the straightening vanes 35 are also installed in the respective air-exhausting nozzles 40A to 40G which are arranged so as to oppose to the respective air-supplying nozzles 34A to 34G. The first perforated plate 35A is installed in a collecting opening 39 and the second perforated plate 35B is installed in the downstream of the collecting opening 39. Thus configured nozzles produce uniform drying air flowing in one direction in respective divided zone 26A to 26G, when a supply air fan 38 and an exhaust fan 44 are driven. Specifically, the drying air flows from one end (air-supplying side) to the other end (air-exhausting side) in the width direction of the web, on the surface of a coating film, as is shown in FIG. 4. Then, one part of an exhaust gas containing an organic solvent vaporized from the surface of the coating film is circulated through an exhaust duct 42 and a circulation duct 46, and is mixed with drying air introduced from an introduction duct 48. Thereby, the drying air containing the organic solvent is supplied to the respective divided zones 26A to 26G, and accordingly can prevent the organic solvent contained in the coating film from instantly evaporating from the surface of the coating film.

In addition, as shown in FIG. 2, air-supplying valves 50A to 50G and air-exhausting valves 52A to 52G are placed respectively in diverged branch pipes of an air-supplying duct 36 and diverged branch pipes of the exhaust duct 42, and the opening degree of the air-supplying valves 50A to 50G and the air-exhausting valves 52A to 52G are controlled by a controller 54. The controller 54 can control the respective valves 50A to 50G and 52A to 52G so that an air velocity slowly decreases as the divided zone approaches to the divided zone 26G in the downstream from the divided zone 26A in the upstream, in a traveling direction of the web. On the other hand, some coating liquid hardly causes an unevenness of drying due to the drying air, as the coating liquid is dried. In this case, the controller 54 can dry the coating film more quickly in the drying zone, by controlling the respective valves 50A to 50G and 52A to 52G so that the air velocity of the drying air slowly increases.

There are two aspects for slowly decreasing the air velocity of the drying air. One is a method of continuously decreasing the air velocity from the divided zone 26A in the upstream to the divided zone 26G in the downstream. The other is a method of decreasing the air velocity step-by-step. Any of the two methods is acceptable.

In addition, a width of a main body 18 of a drying apparatus is formed so as to be larger than that of the web 12. In both sides of the drying zones 26, straightening plates 56 for covering the opened parts in the both sides are installed to form straightening sections. The straightening sections are placed so as to prevent a rapid flow of the drying air from being formed in the drying zone 26, by securing a distance between the supply opening and the end of the coating film and a distance between the end of the coating film and the collecting opening.

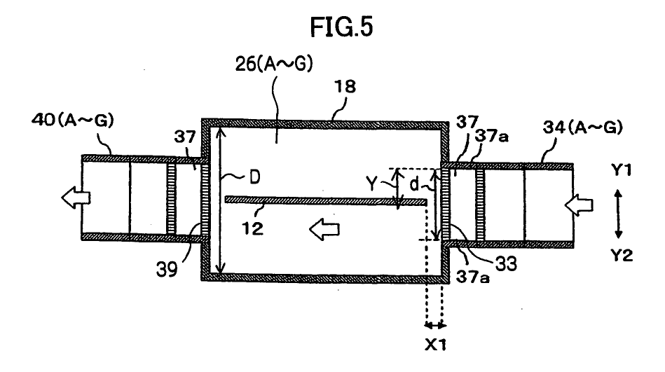

FIG. 5 is an explanatory drawing for describing a positional relationship between air-supplying nozzles 34A to 34G having a supply opening formed into a rectangular shape and a web 12. The figure shows a state of a cross section in a width direction of the web shown in FIG. 4.

As is shown in FIG. 5, the surface of a coating film (in bottom side) on the web 12 is arranged at a position at which drying air that has passed in the vicinity of the inner wall surface of the air-supplying nozzles 34A to 34G does not directly hit the surface of the coating film on the web 12. Specifically, the surface of the coating film on the web 12 is arranged at a position which is surely distant from the inner wall surfaces 37a and 37a (upper inner wall surface and lower inner wall surface) of the air-supplying nozzles 34A to 34G by a clearance (Y) or longer in a direction perpendicular to the surface of the coating film (directions Y1 and Y2 in the figure). The clearance (Y) is preferably 5 mm or longer, and further preferably is 5 to 15 mm.

The positional relationship between the air-supplying nozzles 34A to 34G and the web 12 can be controlled by adjusting the traveling position of the web 12 in the Y-direction.

In addition, it is preferable to set the clearance X1 between the supply opening 33 and the edge of the web 12 at 5 mm or longer, and further preferably to set the clearance X1 at 50 mm or longer, in order to prevent the drying air that has passed in the vicinity of the inner wall surface of the air-supplying nozzles 34A to 34G from directly hitting the surface of the coating film of the web 12.

In the next place, a method for drying a coating film according to the present invention with the use of a drying apparatus 16 configured as described above will be described with reference to FIG. 2 and FIG. 5.

An applicator 14 applies a coating liquid with a wire bar 14A to a web 12 which is supported by support rollers 20, 22 and 24 and travels, and right after the application, the drying apparatus 16 dries the coating film.

When an air-supplying fan 38 and an air-exhausting fan 44 are driven, the air-supplying nozzles produce drying air so as to flow in one direction from one end side (air-supplying side) to the other end side (air-exhausting side) in a width direction of the web, in each divided zone 26A to 26G of a drying zone 26. Thus produced drying air contains a vaporized organic solvent in the vicinity of the surface of the coating film, and is exhausted from the drying zone 26 to gradually dry the coating film.

In the drying zone 26, the web 12 travels in the state of directing the surface of the coating film downward, while keeping such a positional relationship with respect to the air-supplying nozzles 34A to 34G as is shown in FIG. 5. Drying air containing a turbulent airflow in a boundary layer which has been produced in the air-supplying nozzles 34A to 34G does not directly hit the surface of the coating film on the web 12, so that the coating film can be uniformly dried without forming an unevenness of drying.

Concentrations of the organic solvent in the vicinity of the surface of the coating film are occasionally different between an inlet side and an outlet side of the drying zone 26 due to the traveling of the web 12 in the drying zone 26, but the method can eliminate the difference, because the drying zone 26 is divided into a plurality of the zones 26A to 26G. Specifically, the method can eliminate the difference of the concentration of the organic solvent evaporating in the vicinity of the surface of the coating film between the inlet side and the outlet side of the drying zone 26, by controlling the opening degrees of respective air-supplying valves 50A to 50G and air-exhausting valves 52A to 52G for the seven-part divided zones 26A to 26G and adjusting the air velocity of the drying air which flows through the respective divided zones 26A to 26G.

For instance, the method according to the present embodiment can prevent the drying air from forming the unevenness of drying, by slowly decreasing the air velocity of the drying air as the divided zone approaches to the divided zone 26C in the downstream side from the divided zone 26A in the upstream side in a traveling direction of the web, and decreasing the velocity of the drying air in the latter half of the drying zone 26. On the other hand, some coating liquid hardly causes an unevenness of drying due to the drying air, as the coating liquid is dried. In this case, the method can set the velocity of the drying air so as to slowly increase.

In the present embodiment, the traveling direction of the web 12 is the same as the flow direction of drying air, which is a parallel flow, but the direction is not limited thereto. The method can be applied to the case of a counter flow in which the traveling direction of the web 12 is opposite to the flow direction of the drying air. In addition, shapes of air-supplying nozzles 34A to 34G and air-exhausting nozzles 40A to 40G are not limited to those in the above described embodiment.

In the present embodiment, an example of a coating film directing downward is shown, but the direction is not limited thereto. The present invention can be applied to the coating film directing upward.

In the next place, a second embodiment according to the present invention will be described. A drying method according to the present embodiment is a method of adjusting a positional relationship in a Y-direction between a web 12 and a supply opening 33, by using a mechanism of moving an air-supplying nozzle in the Y-direction.

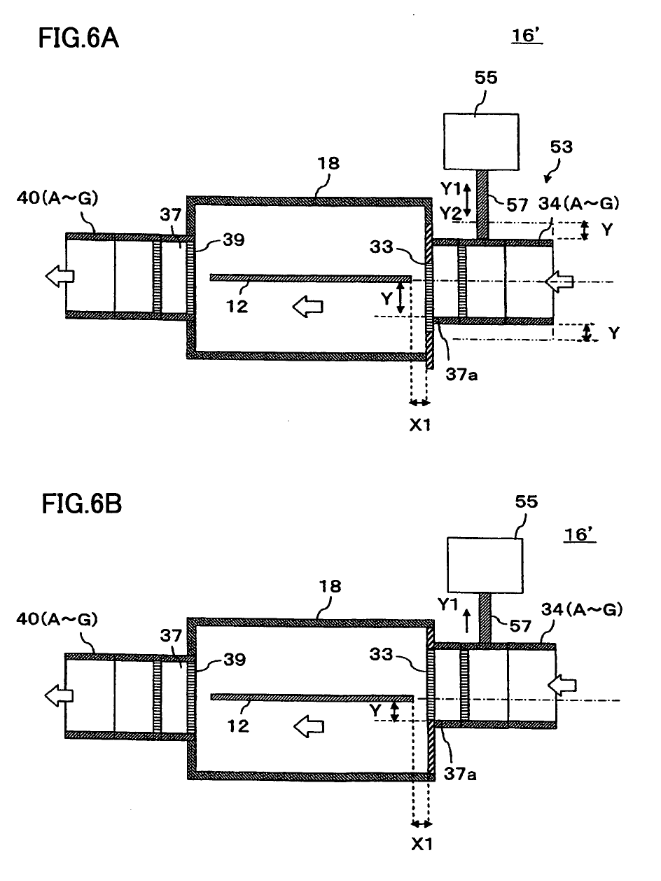

FIGS. 6A and 6B are explanatory drawings for describing a drying apparatus 16′ according to the present embodiment. In the figure, FIG. 6A shows a state before a moving mechanism 53 (moving device) moves air-supplying nozzles 34A to 34G, and FIG. 6B shows a state after the moving mechanism 53 has moved the air-supplying nozzles 34A to 34G in a direction of the arrow Y1. Hereafter, the same member as in the first embodiment or the member having the same function as in the first embodiment will be marked with the same reference numerals, and the detailed description will be omitted.

The drying apparatus 16′ in FIG. 6 has the same structure as in FIG. 5 of the first embodiment, except that drying device 16′ has the moving mechanism 53 for moving the air-supplying nozzles 34A to 34G in a Y-direction.

A side wall of a drying zone 26 connected to the supply opening 33 of the air-supplying nozzles 34A to 34G is flexibly composed of an elastic member such as a rubber member and an accordion member.

As is shown in FIG. 6, the drying device 16′ has the moving mechanism 53 for moving the air-supplying nozzles 34A to 34G in the perpendicular direction (direction of arrows Y1 and Y2 in FIG. 5) to the longitudinal direction of a web 12 installed in the upper part of the air-supplying nozzles 34A to 34G. The moving mechanism 53 has a driving device 55, and a connecting member 57 for connecting the driving device 55 to the outer wall surface of the air-supplying nozzles 34A to 34G. The moving mechanism 53 also has a controlling device which is not shown in the figure and drives the driving device 55 to move the connecting member 57 up and down by a predetermined distance (distance (Y) in the figure) in a direction of arrows Y1 and Y2. Thereby, the air-supplying nozzles 34A to 34G connected to the connecting member 57 can be also moved up and down along with the movement of the connecting member 57, because the end of the supply opening 33 of the air-supplying nozzles 34A to 34G is supported by the elastic member.

In the figure, the moving mechanism 53 may also be provided with a guiding device having a guide rail or a slider, which is not shown, so as to guide the air-supplying nozzles 34A to 34G in the Y1Y2 direction when moving them.

A movement distance (Y) is set in such a range as to satisfy the range according to the present invention, specifically, Y<X1.

Thus configured drying apparatus can change a clearance (Y) so as to satisfy the range according to the present invention as circumstances demand, even when a position of a traveling web 12 and a thickness of the web 12 have changed.

In the next place, a third embodiment according to the present invention will be described. A drying method according to the present embodiment is a method of removing a turbulent airflow in a boundary layer produced in an air-supplying nozzle in a drying zone for generating drying air in one width direction of a support, and supplying the remaining air.

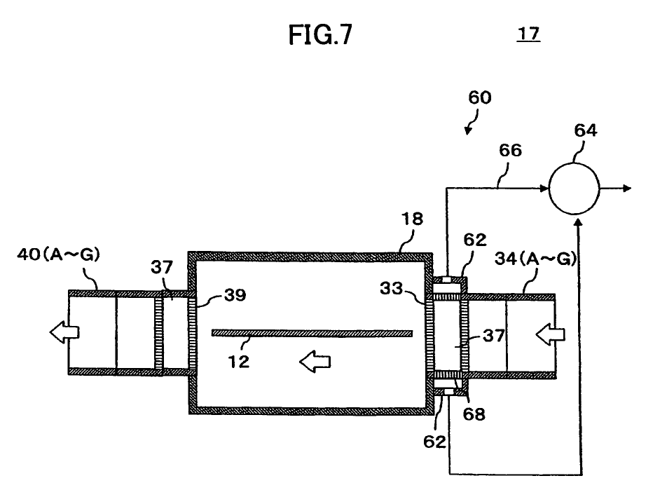

FIG. 7 is a sectional view for describing a drying apparatus 17 according to the present embodiment. Hereafter, the same member as in the first embodiment or the member having the same function as in the first embodiment will be marked with the same reference numerals, and the detailed description will be omitted.

As shown in FIG. 7, the drying apparatus 17 has almost the same configuration as in FIG. 5, except that the drying apparatus 17 has a sucking mechanism 60 (sucking device) for the turbulent airflow in the boundary layer installed right in front of a supply opening 33 of air-supplying nozzles 34A to 34G.

The sucking mechanism 60 for the turbulent airflow in the boundary layer is mainly composed of a sucking chamber 62 for sucking the turbulent airflow in the boundary layer on the inner wall surface of a pressure-uniformizing chamber 37, and a sucking pipeline 66 for connecting the sucking chamber 62 to a sucking pump 64. In addition, a straightening plate 68 is provided in a border between the pressure-uniformizing chamber 37 and the sucking chamber 62.

Thus configured sucking mechanism 60 can suck and remove the turbulent airflow in the boundary layer, right before the drying air is supplied. Accordingly, the drying apparatus can inhibit the turbulent airflow in the boundary layer from directly hitting the surface of a coating film, even without adjusting a position of a web 12 as in the first embodiment, specifically without adjusting a clearance (Y) between the surface of the coating film and the inner wall surface 37a of the air-supplying nozzles 34A to 34G.

The amount of air to be sucked and removed from the boundary layer component is in a range of 5 to 20% with respect to the total amount of the air blown from the air-supplying nozzles 34A to 34G.

In the present embodiment, a case is shown which has a sucking mechanism 60 for a turbulent airflow in a boundary layer installed in a pressure-uniformizing chamber 37 right in front of a supply opening 33. However, the case is not limited thereto, but the same mechanism can also be installed in an upper stream side than the pressure-uniformizing chamber 37.

In the present embodiment, a case is shown in which the surface of a coating film directs downward, but the case is not limited thereto. The present invention can be also applied to the surface of the coating film directing upward.

In the next place, a fourth embodiment according to the present invention will be described. A drying method according to the present embodiment is a method of removing a turbulent airflow in a boundary layer produced in an air-supplying nozzle in a drying zone for generating drying air in one traveling direction of a support, and supplying the remaining air.

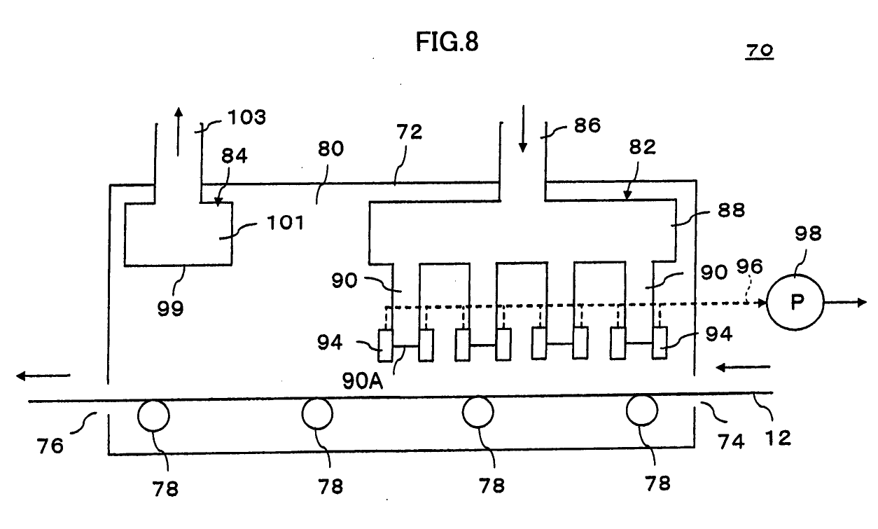

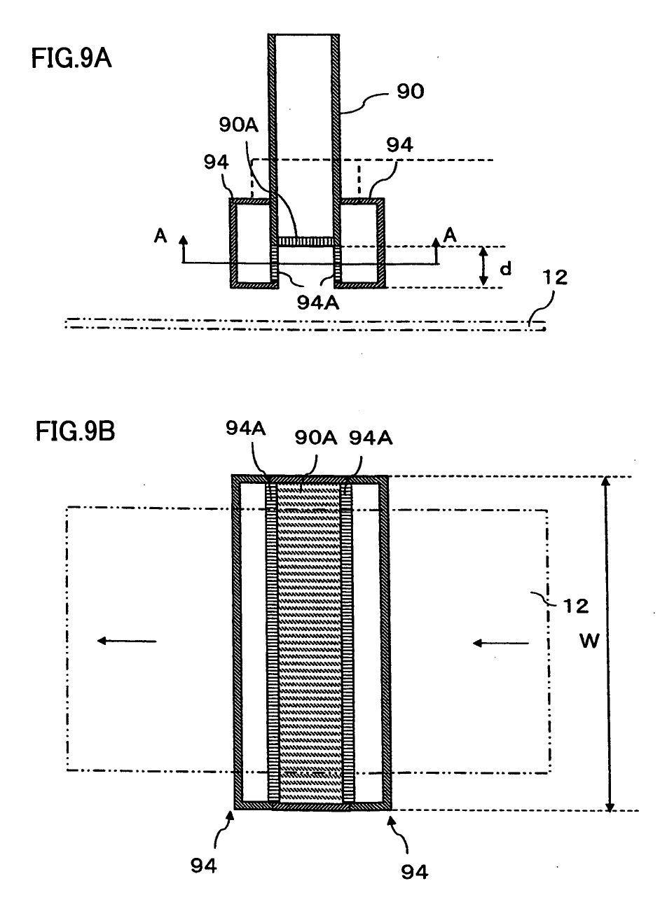

FIG. 8 is an explanatory drawing for describing a drying apparatus 70 in the fourth embodiment. FIGS. 9A and 9B are partial sectional views of an air-supplying nozzle of FIG. 8. In the figure, FIG. 9A is an enlarged partial sectional view of the air-supplying nozzle, and FIG. 9B is a sectional view taken along the line A-A shown in FIG. 9A.

As is shown in FIG. 8, a main body of a drying apparatus 72 is formed into a rectangular box shape parallel to the coating film side of a traveling web 12 (bottom surface of web), and has an inlet 74 through which the web 12 is carried in and an outlet 76 through which the web 12 is carried out, respectively formed in both ends in the traveling direction of the web 12. The inner part of the main body of the drying apparatus 72 has a plurality of support rollers 78 for forming a transportation path of the web 12 to form a drying zone 80.

The drying zone 80 has an air-supplying portion 82 for supplying drying air and an air-exhausting portion 84 for exhausting drying air from the inside of the drying zone 80 to the outside arranged therein.

The air-supplying portion 82 has a pressure-uniformizing chamber 88 which is arranged in a coating film surface side of the web 12 and is provided with a supply port 86 for supplying drying air sent from an air-supplying fan through an air-supplying duct and the like; a plurality of air-supplying nozzles 90 which are branched from the pressure-uniformizing chamber 88 and blow drying air; and sucking portions 94 (sucking device) which are formed on the outer periphery of the supply opening 90A of the air-supplying nozzles 90, and suck a boundary layer in the vicinity of an inner wall surface of the air-supplying nozzle 90.

The supply opening 90A at the leading edge of the air-supplying nozzle 90 is formed into a slit shape having a width larger than that of the coating film surface and is provided with a straightening plate 92, as shown in FIG. 9B.

The sucking portion 94 has a sucking surface 94A provided with a straightening plate arranged on the outer periphery of the supply opening 90A, as is shown in FIG. 9A. The sucking portion 94 is connected to a sucking pump 98 through a sucking pipe 96 (see FIG. 8).

The amount of air to be sucked and removed from the boundary layer component is preferably in a range of 5 to 20% with respect to the total amount of the air blown from air-supplying nozzles 34A to 34G. In addition, an opening area of the sucking surface 94A and a size of the sucking portion 94 are set so as to realize the above described suction rate.

Thereby, the sucking portion 94 sucks a turbulent airflow in a boundary layer produced in the vicinity of an inner wall surface of the air-supplying nozzle 90, out of drying air blown from a supply opening 92A, and the air-supplying nozzle 90 supplies only stable drying air to the surface of the coating film.

An air-exhausting portion 84 has a pressure-uniformizing chamber 101 which is arranged on the coating film surface side of the web 12 similarly to the case of the air-supplying portion 82, is arranged in the air-exhausting side, and is formed in the upper space of a collecting opening 99A provided with a straightening plate 99; and an exhaust opening 103 which is connected to the above described air-exhausting duct for drying air and an air-exhausting fan, in the pressure-uniformizing room 101.

Thereby, the drying apparatus can uniformly exhaust the drying air which has been blown from the air-supplying portion 82 and flows on the surface of the coating film into the air-exhausting portion 84. An air-supplying/air-exhausting system in the present embodiment can have the same configuration as in the first embodiment (FIG. 2).

In the next place, a method for drying a coating film according to the present invention will be described, which employs the drying apparatus 70 configured as in the above description and shown in FIG. 8.

Support rollers 78 support a traveling web 12. The drying apparatus 70 dries the coating film formed from a coating liquid which has been applied on the web 12.

When an air-supplying fan and an air-exhausting fan (though both are not shown in the figure) are driven, air-supplying nozzles produce drying air which flows in one direction from an air-supplying side to an air-exhausting side in a traveling direction of the web, in a drying zone 80.

At this time, in each air-supplying nozzle 90, the drying air is supplied to the surface of the coating film after a turbulent airflow in a boundary layer has been sucked and removed at a sucking portion 94 which is installed on the outer periphery of a supply opening 90A. Accordingly, the drying method can inhibit the turbulent airflow in the boundary layer from directly hitting the surface of the coating film, and inhibit an unevenness of drying from occurring.

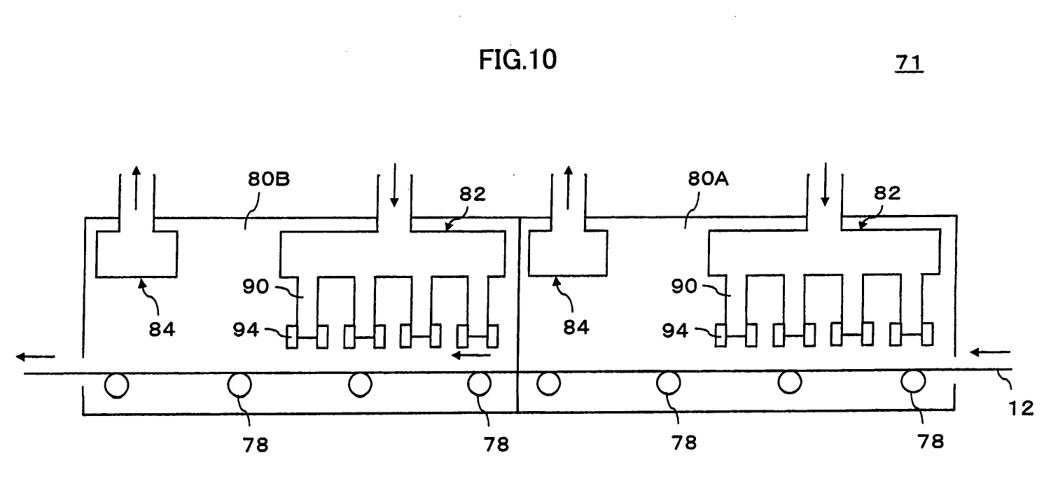

In the present embodiment, a case has been shown in which the coating film is dried in one drying zone 80, but the method is not limited to the case. Such a method can be employed, for instance, as to install a plurality of drying zones 80A, 80B and so on as shown in FIG. 10, and change dry conditions in each drying zone. For example, it is also acceptable, as in the case of the first embodiment, to control each air-supplying valve and air-exhausting valve with a controller so that an air velocity of drying air slowly decreases (or increases) as the position approaches to the drying zone 80 in the downstream from the drying zone 80 in the upstream in a traveling direction of a web. There are two aspects for slowly decreasing the air velocity of the drying air. One is a method of continuously decreasing the air velocity from the drying zone 80 in the upstream to the drying zone 80 in the downstream. The other is a method of decreasing the air velocity step-by-step.

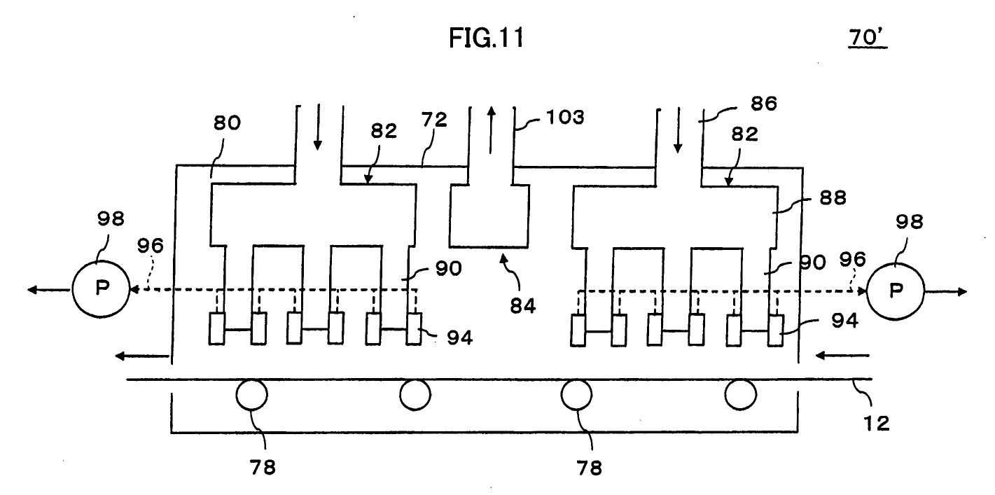

In addition, in the present embodiment, a case is shown in which one air-supplying portion 82 and one air-exhausting portion 84 are installed in one drying zone 80, but the is not limited the case. It is also acceptable, for instance, to arbitrarily arrange the air-supplying portion 82 and the air-exhausting portion 84 in one drying zone 80, as shown in a drying apparatus 70′ in FIG. 11.

The configuration of the sucking portion 94 also is not limited to the above described aspect. It is also possible, for instance, to install the sucking portion 94 right in front of the position at which drying air is blown from a supply opening 92A. In addition, the sucking portion 94 can be formed on the whole circumference of the supply opening 90A.

Furthermore, in the present embodiment, a case is shown in which the surface of the coating film directs upward, but the method is not limited to the case. The present invention can be also applied to the coating film directing downward.

Drying apparatuses according to the first to fourth embodiments described above can inhibit a turbulent airflow in a boundary layer in drying air to be supplied from hitting the surface of a coating film, and prevent an unevenness of drying.

In the above description, embodiments on a method for drying the coating film according to the present invention were described, but the present invention is not limited to the above described embodiments, and can adopt various forms.

For instance, in the above described respective embodiments, a traveling direction of the web 12 is the same as the flow direction of drying air, which is a parallel flow, but the method is not limited to the case. The method can be applied to the case of a counter flow in which the traveling direction of the web 12 is opposite to the flow direction of the drying air.

The specific configuration of the drying apparatus is not limited to the above described respective embodiments, as long as the method for drying the coating film according to the present invention can be applied to the configuration.

In addition, the number of coating layers (coating films) formed from a coating liquid to be simultaneously applied in the present invention is not limited to a single layer. The method according to the present invention can be applied to a simultaneously multilayer-coating method, as needed.

In the next place, various materials to be used in the present invention will be described.

An organic solvent of a coating liquid to be used in the present invention includes: a single substance of methyl ethyl ketone (MEK), acetone, methyl isobutyl ketone (MIBK), methanol, ethanol, n-propanol and methyl acetate; and a mixture thereof. The particularly preferable organic solvent has a boiling point of 100° C. or lower.

A web 12 to be used in the present invention includes: a plastic film formed from a resin such as polyethylene terephthalate, polyethylene-2,6naphthalate, cellulose diacetate, cellulose triacetate, cellulose acetate propionate, polyvinyl chloride, polyvinylidene chloride, polycarbonate, polyimide and polyamide; paper; a paper coated or laminated with α-polyolefin having 2 to 10 carbon atoms such as polyethylene, polypropylene, an ethylene butene copolymer; a metallic foil of aluminum, copper, tin and the like; and a belt-shaped substrate preliminary having a worked layer formed on the surface, each with a width of 0.3 to 5 m, a length of 45 to 10,000 m and a thickness of 5 to 200 μm in general. Furthermore, the above described web 12 includes a material which has a surface coated with an optical compensation sheet coating liquid, a magnetic coating liquid, a photography photosensitive coating liquid, and a coating liquid for surface protection, static charge prevention and lubrication, and then dried, and which is then cut into a desired length and width. The representative example includes an optical compensation sheet, various photographic films, a photographic printing paper and a magnetic tape.

A usable method for applying an coating liquid includes a curtain coating method, an extrusion coating method, a roll coating method, a dip coating method, a spin coating method, a print coating method, a spray coating method and a slide coating method, in addition to the above described bar coating method. Particularly, the bar coating method, the extrusion coating method and the slide coating method can be preferably used.

In the next place, a method for producing an optical compensation sheet by employing a method for drying a coating film according to the present invention, and a liquid crystal display device using the optical compensation sheet will be described.

[Optical Compensation Sheet for LCD]

A liquid crystal display device will be now described below which uses an optical compensation sheet having an optical anisotropic layer containing a discotic compound coated on a transparent support of a cellulose acylate film, as a film for protecting directly a polarizing plate, but the liquid crystal display device is not limited to the description.

The discotic compound to be used in the above optical anisotropic layer and the like is disclosed in each bulletin of Japanese Patent Application Laid-Open No. H07-267902, Japanese Patent Application Laid-Open No. H07-281028 and Japanese Patent Application Laid-Open No. H07-306317. According to the patents, the optical anisotropic layer is a layer containing a compound having a discotic structural unit. Specifically, the optical anisotropic layer is a layer of a liquid-crystalline discotic compound having a low molecular weight such as a monomer, or a polymer layer obtained by polymerizing (curing) a polymerizable liquid-crystalline discotic compound. An example of the discotic (discoidal) compounds includes: a benzene derivative described in the report written by C. Destrade, et al. in Mol. Cryst., Vol. 71, p 111 (1981); a torxene derivative described in the report written by C. Destrade, et al. in Mol. Cryst., Vol. 122, p 141 (1985) and in Physics lett, A, Vol. 78, p 82 (1990); a cyclohexane derivative described in the report written by B. Kohne et al. in Angew. Chem. Vol. 96, p 70 (1984); and an azacrown compound or a phenyl acetylene macrocycle compound described in the report written by J. M. Lehn, et al. in J. Chem. Commun., p 1794 (1985), and in the report written by J. Zhang in J. Am. Chem. Soc. Vol. 116, p 2655 (1994). The above described discotic (discoidal) compound has a structure in which the discotic (discoidal) compound exists in the center of a molecule as a nuclear in general and a straight-chain alkyl group or alkoxy group, a substituted benzoyloxy group and the like are radially substituted as the straight chain of the molecule; shows liquid crystalline properties; and includes a discotic liquid crystal in general. However, when the molecule in itself has one negative uniaxis and can be imparted with a fixed orientation, the molecule is not limited to the above description. In addition, the optical anisotropic layer formed from the discoidal compound in the above described bulletin does not necessarily mean that a finally produced substance is the above described compound, but includes, for instance, an optical anisotropic layer in which the above described low molecular discotic liquid crystal has a group reacting with heat or light, consequently is polymerized or cross-linked by the heat or light, acquires high molecular weight, and has lost the liquid crystalline properties. Furthermore, the optical anisotropic layer preferably employs a compound that contains at least one of discoidal compounds which can form a discotic nematic phase or a uniaxial pillar phase, and that has an optical anisotropy. In addition, the discoidal compound is preferably a triphenylene derivative. Here, the triphenylene derivative is preferably a compound shown by (Chemical Formula 2) according to Japanese Patent Application Laid-Open No. H07-306317.

A cellulose acylate film is preferably used as a support of an orientational film. Applicable cellulose acylate film and orientational film are described in Japanese Patent Application Laid-Open No. H09-152509 in detail. Specifically, the orientational film is provided on the cellulose acrylate film prepared in the present invention, or on an underlayer coated on the cellulose acylate film. The orientational film functions so as to specify an orientation of a liquid crystalline discotic compound provided thereon. Here, the orientational film may be any layer, as long as the film can impart orientation to the optical anisotropic layer.

A preferred example of an orientational film includes: a rubbed layer of an organic compound (preferably polymer); a layer of an obliquely vapor-deposited inorganic compound; a layer having a microgroove; a built-up film formed of ω-tricosane acid, dioctadecyl methylammonium chloride and methyl stearylate by using a Langmuir-Blodgett's technique (LB film); and a layer having a dielectric substance orientated by the application of an electric field or a magnetic field.

An example of the organic compound for the orientational film includes: a polymer such as polymethyl methacrylate, acrylic acid/methacrylic acid copolymer, styrene/maleinimide copolymer, polyvinyl alcohol, poly (N-methylolacrylamide), styrene/vinyltoluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, carboxymethyl cellulose, polyethylene, polypropylene and polycarbonate; and a compound such as a silane coupling agent. A preferred example of the polymer includes: polyimide; polystyrene; a polymer of a styrene derivative; gelatine; a polyvinyl alcohol; and an alkyl-modified polyvinyl alcohol having an alkyl group (preferably having 6 or more carbon atoms).

Above all, the alkyl-modified polyvinyl alcohol is particularly preferable, and is superior in the capability of uniformly orientating the liquid crystalline discotic compound. This is assumed to be because there is a strong interaction between the alkyl chain on the surface of the orientational film and an alkyl side chain of the discotic liquid crystal. The alkyl group preferably has 6 to 14 carbon atoms, and further preferably is coupled with the polyvinyl alcohol through —S—, —(CH₃)C(CN)—, or —(C₂H₅)N—CS—S—. The above described alkyl-modified polyvinyl alcohol has the alkyl group on its terminal, and preferably has a saponification degree of 80% or higher and a polymerization degree of 200 or higher. A commercially available product such as MP103, MP203 and R1130 made by Kuraray Co., Ltd. can be used for the above described polyvinyl alcohol having the alkyl group as the side chain.

In addition, a polyimide film (preferably made from polyimide containing fluorine atom) which has been widely used as an orientational film of LCD is also preferable as an organic orientational film. The polyimide film is obtained by applying polyamic acid (e.g., LQ/LX series made by Hitachi Chemical Co., Ltd. and SE series made by Nissan Chemical Industries, Ltd.) onto a support face, baking the support at 100 to 300° C. for 0.5 to 1 hour, and then rubbing the coating film.

Furthermore, an orientational film to be applied to a cellulose acylate film according to the present invention is preferably a cured film obtained by curing the polymer which has a reactive group introduced into the above described polymer, or by curing the above described polymer with the concomitant use of a crosslinking agent such as an isocyanate compound and an epoxy compound.

The polymer to be used for the orientational film is preferably chemically coupled with a liquid crystalline compound of an optical anisotropic layer through an interface between the orientational film and the optical anisotropic layer. The polymer of the orientational film is preferably formed of a polyvinyl alcohol which has a group having a vinyl part, an oxilanyl part or an aziridinyl part substituting for at least one hydroxyl group. The group having the vinyl part, the oxilanyl part or the aziridinyl part is preferably coupled with the polymer chain of a polyvinyl alcohol derivative through an ether bond, a urethane bond, an acetal bond or an ester bond. The group having the vinyl part, the oxilanyl part or the aziridinyl part has preferably no aromatic ring. The above described polyvinyl alcohol has preferably a structure shown in (Chemical Formula 22) described in Japanese Patent Application Laid-Open No. H09-152509.

In addition, the above described rubbing treatment can be employed from among treatment methods which have been widely adopted as a process of orientating the liquid crystals of LCD. Specifically, a usable method is to impart an orientation to the film by rubbing the surface of the orientational film in a fixed direction with the use of paper, gauze, felt paper, rubber, nylon or polyester fiber. In general, the treatment is conducted by rubbing the surface several times with a flocked fabric with fibers having uniform length and thickness.

A vapor-depositing substance of an inorganic oblique vapor-deposition film includes: an metallic oxide such as SiO which is a typical example, TiO₂ and ZnO₂; a fluoride such as MgF₂; and a metal such as Au and Al. The metallic oxide to be used for an oblique vapor-deposition substance is not limited to the above described examples, as long as the metallic oxide has a high dielectric constant. The inorganic oblique vapor-deposition film can be formed by using a vapor deposition apparatus. The inorganic oblique vapor-deposition film can be formed by fixing a film (support) and vapor-depositing the substance onto the film, or moving a long film and continuously vapor-depositing the substance onto the film. A method of orientating an optical anisotropic layer without using the orientational film includes a method of applying an electric field or a magnetic field to the optical anisotropic layer on the support while heating the optical anisotropic layer to a temperature at which a discotic liquid crystal layer can be formed.

A cellulose acylate film can be applied to an optical compensation sheet having a basic structure described in Japanese Patent Application Laid-Open No. H08-5837, Japanese Patent Application Laid-Open No. H07-191217, Japanese Patent Application Laid-Open No. H08-50206 and Japanese Patent Application Laid-Open No. H07-281028 in detail, which will be described below. The application example is an optical compensation sheet comprising the cellulose acylate film and an optical anisotropic layer provided thereon, wherein the optical anisotropic layer is formed of a compound having a discotic structural unit. The above described optical compensation sheet is applied to an LCD preferably by affixing the optical compensation sheet to one side of a polarizing plate with a pressure sensitive adhesive, or affixing the optical compensation sheet to one side of a polarizing element with an adhesive as a protection film, for instance. An optical anisotropic element preferably has at least a discotic structural unit (preferably discotic liquid crystal).

It is preferable that a disk face (hereinafter referred to as “face” simply) of the discotic structural unit is inclined to the surface of the cellulose acylate film, and that angles formed by the disk faces of the discotic structural unit and the cellulose acylate film vary in a depth direction of the optical anisotropic layer.

Preferred aspects of the above described optical compensation sheet to be used together with the cellulose acylate film are described in the followings:

(b1) a mean value of the angles increases as a distance between the discotic structural unit and the bottom face of the optical anisotropic layer increases in a depth direction of the optical anisotropic layer;

(b2) the angles vary in a range between 5 to 85 degrees;

(b3) the minimal value of the angles is in a range between 0 and 85 degrees (preferably between 0 and 40 degrees), and the maximal value is in a range between 5 and 90 degrees (preferably between 50 and 85 degrees);

(b4) the difference between the maximal value and the minimal value of the angle is in a range between 5 and 70 degrees (preferably between 10 and 60 degrees);

(b5) the angle continuously varies (preferably increases) as a distance between the discotic structural unit and the bottom face of the optical anisotropic layer varies in a depth direction of the optical anisotropic layer;

(b6) the optical anisotropic layer further includes cellulose acylate;

(b7) the optical anisotropic layer further includes cellulose acetate butylate;

(b8) an orientational film (preferably cured film of polymer) is formed between the optical anisotropic layer and a transparent support;

(b9) an undercoating layer is formed between the optical anisotropic layer and the orientational film:

(b10) the optical anisotropic layer has the minimal value of the absolute value of a retardation except zero in a tilted direction from the normal line of the optical compensation sheet; and

(b11) the optical compensation sheet according to the above described (b8), in which the orientational film is a rubbing-treated polymer layer.

The optical anisotropic layer preferably includes an organic compound which can vary the orientating temperature of the optical anisotropic layer when added into the optical anisotropic layer. The organic compound is preferably a monomer having a polymerizable group.

A method for producing the described optical compensation sheet to which a cellulose acylate film is applied is described in detail in Japanese Patent Application Laid-Open No. H09-73081, Japanese Patent Application Laid-Open No. H08-160431 and Japanese Patent Application Laid-Open No. H09-73016, but is not limited to the patents.

An example of the method for producing the optical compensation sheet will be now described below.

(c1) A transparent resin layer is formed on the surface of a long cellulose acylate film which has been paid off, by applying a coating liquid containing a resin for forming an orientational film thereon, and drying the coating liquid.

(c2) The surface of the transparent resin layer is converted into the orientational film by rubbing the surface with the use of a rubbing roller. The surface of the orientational film on the film substrate is preferably continuously rubbing-treated, by arranging the rubbing roller in between two transportation rollers existing in a continuous transportation step for the film substrate, and transporting the film substrate while making the rotating rubbing roller lap the film. It is also possible to arrange the rubbing roller so as to incline the rotation axis with respect to a transportation direction of the film substrate. The rubbing roller preferably has a circularity, a cylindricality and a deflection of each 30 μm or lower. An apparatus using the above described rubbing method is preferably provided with one set of or more spare rubbing rollers.

(c3) A coating liquid containing a liquid crystalline discotic compound is applied onto the orientational film. An application method to be used can be appropriately selected from among a dip coating method, an air knife coating method, a curtain coating method, a roll coating method, a wire bar coating method, a gravure coating method, a microgravure method and an extrusion coating method (U.S. Pat. No. 2,681,294).

It is preferable to rubbing-treat the surface of the transparent resin layer while removing dust on the rubbing roller, and to remove dust on the surface of the rubbing-treated resin layer. A liquid crystalline discotic compound with a cross-linking functional group is used for the liquid crystalline discotic compound. A liquid crystal layer of a discotic nematic phase is preferably formed by vaporizing the solvent in the surface of the formed coating layer (coating film) by applying a method for drying the coating film according to the present invention, and heating the coating layer from which most parts of the solvent has been vaporized.

(c4) It is preferable to dry the coated layer, then heating the coated layer to form the liquid crystal layer of the discotic nematic phase, and continuously irradiate the liquid crystal layer with light to cure the discotic liquid crystal. It is preferable to heat the coating layer by applying hot blast or far infrared rays to the side having no liquid crystal layer of the transparent resin film, or by bringing a heating roller in contact with the side. It is also preferable to heat the coating layer which has been dried by applying hot blast or far infrared rays to both faces of the transparent resin film.

(c5) It is preferable to wind up a cellulose acylate film having the orientational film and the liquid crystal layer formed thereon.

[Application Method of Optical Compensation Sheet for LCD]

In the next place, an example of applying a cellulose acylate film to a panel will be shown. The above examples are disclosed in detail in each bulletin of Japanese Patent Application Laid-Open No. H08-95034, Japanese Patent Application Laid-Open No. 09-197397, and Japanese Patent Application Laid-Open No. H11-316378. An optical compensation sheet described in the above each bulletin is advantageously used for a liquid crystal display device, in particular, a transmission type of a liquid crystal display device. The transmission type of the liquid crystal display device is composed of a liquid crystal cell and two polarizing plates arranged on both sides thereof. The liquid crystal cell carries a liquid crystal in between two sheets of electrode substrates. One optical compensation sheet is placed in between the liquid crystal cell and one polarizing plate, or two optical compensation sheets are placed in between the liquid crystal cell and both of the polarizing plates. A mode of the liquid crystal cell is preferably a VA mode, a TN mode or an OCB mode.

[Antiglare Film and Antireflection Film]

The cellulose acylate film is preferably applied to an antiglare film or an antireflection film. One or both of an anti-glare layer and an anti-reflection layer can be given on one side or both sides of the cellulose acylate film for the purpose of improving visibility of a flat panel display such as an LCD, a PDP, a CRT and an EL. The film to which such functions are given is referred to as the antiglare film or the antireflection film, and a film having both the anti-glare layer and the anti-reflection layer is referred to as an anti-glare antireflection film. In general, the antiglare film is composed of a transparent support and an anti-glare layer, and the antireflection film is provided with the anti-reflection layer formed of one or more light interference layers placed on the outermost surface of the transparent support. A hard coat layer or the anti-glare layer is installed between the support and the light interference layer, as needed.

The transparent support is preferably a cellulose acylate film for the application of an LCD, and is particularly preferably a cellulose acetate. When the antiglare film or the antireflection film according to the present invention is applied to an LCD, the film is arranged on the outermost surface of a display unit or an interface between the inner part of the display unit and air, by arranging an adhesive layer on one side or by a similar method. It is preferable from the viewpoint of the cost and thinning of the display unit to apply the antiglare film or the antireflection film according to the present invention directly in the state to a protective film for protecting a polarizer of a polarizing plate, because the cellulose triacetate is used for the protective film.

At first, preferred aspects of the antiglare film and the antireflection film will be now described below.

(Aspect A1) In an anti-glare antireflection film including a cellulose acylate film and a low refractive index layer which contains a fluorine-containing resin and has at least one layer with a refractive index of 1.30 to 1.49, the anti-glare antireflection film has the anti-glare layer including a binder with a refractive index of 1.50 to 2.00 in between the cellulose acylate film and the low refractive index layer.

(Aspect A1-2) In an anti-glare antireflection film including a cellulose acylate film and a low refractive index layer which contains a fluorine-containing resin and has at least one layer with a refractive index of 1.30 to 1.49, an antireflection film has a hard coat layer including a binder with a refractive index of 1.50 to 2.00 in between the cellulose acylate film and the low refractive index layer.

(Aspect A2) The anti-glare antireflection film according to the aspect A1 further has at least one hard coat layer in between the cellulose acylate film produced in the present invention and the anti-glare layer.

(Aspect A3) The anti-glare antireflection or clear type antireflection film according to the aspect A1 or A1-2 or A2, wherein the low refractive index layer containing the above described fluorine-containing resin has thermal curability or ionizing radiation curability.

(Aspect A4) The anti-glare antireflection film according to the aspect A3, wherein the above described anti-glare layer comprises matte fine particles and a binder containing an ionizing radiation curable resin.

(Aspect A4-1) The antireflection film according to the aspect A1-2, wherein the above described hard coat layer is formed of a binder containing the ionizing radiation curable resin.

(Aspect A5) The anti-glare antireflection film according to the aspect A4, wherein a difference between the refractive indices of the matte fine particles and the binder containing the ionizing radiation curable resin in the above described anti-glare layer is less than 0.05.

(Aspect A6) The anti-glare antireflection film according to the aspect A4, wherein the average particle size of the matte fine particles is 1 μm to 10 μm in the above described anti-glare layer.

(Aspect A7) The anti-glare antireflection film according to the aspect A4, wherein the above described binder having the refractive index of 1.50 to 2.00 is a thermo-curable substance or ionizing radiation curable substance of a mixture of a high refractive index monomer and a (meth)acrylate monomer having three or more functional groups, in the above described anti-glare layer.

(Aspect A8) The anti-glare antireflection film according to the aspect A4, wherein the above described binder having the refractive index of 1.50 to 2.00 is the thermo-curable substance or the ionizing radiation curable substance of a mixture of ultra-fine particles of an oxide of a metal selected from among Al, Zr, Zn, Ti, In and Sn and the (meth)acrylate monomer having three or more functional groups, in the above described anti-glare layer.

(Aspect A9) The anti-glare antireflection film according to any one of the aspect A4 to the Aspect A8, wherein the low refractive index layer containing the above described fluorine-containing resin has a dynamic friction coefficient of 0.03 to 0.15 and a contact angle with respect to water of 90 to 120 degrees.

(Aspect A10) A polarizing plate uses the anti-glare antireflection film according to any one of the aspects A1 to A9 in at least one of two protective films of a polarizing layer in the polarizing plate.

(Aspect A11) A liquid crystal display uses the anti-glare antireflection film according to any one of the aspects A1 to A9 or the anti-reflection layer of the anti-glare anti-reflection polarizing plate according to the aspect A10 for the outermost surface layer of a display unit.

(Aspect A12) The anti-reflection film according to the aspect 1 has a high refractive index layer having a refractive index of 1.65 to 2.40 and a low refractive index layer having a refractive index of 1.20 to 1.55, wherein the high refractive index layer includes 5 to 65 vol. % of inorganic particles having an average particle size of 1 to 200 nm and 35 to 95 vol. % of a polymer having a cross-linking anionic group.

(Aspect A12-1) The anti-reflection film is formed by the step of stacking a high refractive index layer having a refractive index of 1.65 to 2.40, a middle refractive index layer having a refractive index of 1.4 to 1.7 and a low refractive index layer having a refractive index of 1.2 to 1.55, in order of low, high and middle refractive indices. When stacking the three refractive index layers, the refractive index of the middle refractive index layer is adjusted into a value in between the high refractive index and the low refractive index.

(Aspect A13) The anti-reflection film according to the aspect A12, wherein the polymer having the anionic group of the high refractive index layer has a phosphate group or a sulfonate group as the anionic group.

(Aspect A14) The anti-reflection film according to the aspect A12, wherein the polymer having the anionic group of the high refractive index layer further has an amino group or an ammonium group.

(Aspect A15) The anti-reflection film according to the aspect A12, wherein the inorganic fine particles of the high refractive index layer have a refractive index of 1.80 to 2.80.

(Aspect A16) The anti-reflection film according to the aspect A12, wherein the high refractive index layer is formed with a coating method, and the polymer having the anionic group is formed by a polymerization reaction caused at the same time when the layer is coated or after the layer has been coated.

(Aspect A17) The anti-reflection film according to the aspect A12, wherein the low refractive index layer is formed of a fluorine-containing resin and has thermal curability or ionizing radiation curability.

(Aspect A18) The anti-reflection film according to the aspect A12, wherein the low refractive index layer is a layer that includes 50 to 95 mass % of inorganic particles having an average particle size of 0.5 to 200 mm and 5 to 50 mass % of the polymer, and has micro-voids formed between the inorganic fine particles which have been stacked into at least two layers.

(Aspect A19) An anti-glare antireflection film has uneven geometry on the surface of the anti-reflection film according to any one of the aspects A12 to A18, wherein the low refractive index layer and the high refractive index layer have substantially uniform film thickness.

(Aspect A20) A method for producing an anti-glare antireflection film according to the aspect A19 comprises the steps of: forming at least one layer having the lower refractive index than that of a support on a transparent support; and forming surface unevenness on at least one side of the transparent support by a pressure from the outside, in this order.

(Aspect A21) A polarizing plate has the antireflection film according to any one of the aspects A12 to A20 stuck on one side or both sides of the polarizing plate, as a protective film of a polarizer, or as a film bonded to the surface of the protective film.

(Aspect A22) A picture display unit has the polarizing plate according to the aspect A21 arranged so that the low refractive index layer arranged on the outermost surface of at least one side can be in a viewer side.

The anti-glare antireflection film according to the present invention can have the hard coat layer thereon, as needed. The compound to be used for the hard coat layer is preferably a polymer having a saturated hydrocarbon or a polyether as a principal chain, and has preferably a cross-linked structure. It is preferable for obtaining the polymer having the cross-linked structure to cross-link a monomer having two or more ethylenic unsaturated groups by applying ionizing radiation or heat.

Examples of the monomer having the two or more ethylenic unsaturated groups include: an ester of a polyhydric alcohol and (meth)acrylic acid (for instance, ethyleneglycol di(meth)acrylate), 1,4-dichlorohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, 1,2,3-cyclohexane tetramethacrylate, polyurethane polyacrylate, polyester polyacrylate); vinylbenzene and a derivative thereof (for instance, 1,4-divinylbenzene, 4-vinyl benzoic acid-2-acryloyl ethyl ester, 1,4-divinyl cyclohexanone); vinyl sulfone (for instance, divinyl sulfone); acrylamide (for instance, methylene bisacrylamide); and methacrylamide.

The polymer having the polyether as the principal chain is preferably synthesized by a ring-opening polymerization reaction of a polyfunctional epoxy compound. The monomers having the ethylenic unsaturated groups need to be cured by the polymerization reaction due to the ionizing radiation or heat after having been coated.

As a substitute for or in addition to the monomer having the two or more ethylenic unsaturated groups, a cross-linked structure may be introduced into a binder polymer by a reaction of a cross-linkable group. Examples of the cross-linking functional group include an isocyanate group, an epoxy group, an aziridine group, an oxazoline group, an aldehyde group, a carbonyl group, a hydrazine group, a carboxyl group, a methylol group and an active methylene group. Vinylsulfonic acid, an acid anhydride, a cyanoacrylate derivative, melamine, an etherificated methylol, an ester, urethane, and a metalalkoxide such as tetramethoxy silane can be also used as the monomer for introducing the cross-linked structure. A functional group such as a block isocyanate group may be used, which shows cross-likability as a result of a decomposition reaction. In addition, the cross-linking group according to the present invention is not limited to the above described compounds, but may be a compound which shows reactivity after the functional group has been decomposed. The compounds having these cross-linking groups need to be cross-linked by heat after having been coated.

Various techniques for imparting anti-glare properties to a film are disclosed in patent publications, such as (1) a method of dispersing matte particles having a particle size of scattering visible light in a binder to form an anti-glare layer having surface unevenness, (2) a method of forming the unevenness on the surface of a support by embossing or sandblasting the support, and (3) a method of imparting the unevenness onto the surface employing a coating composition having the phase separation structure. However, generally, (4) a method of dispersing the matte particles in the binder is practically used.

An anti-glare layer is formed with the use of fine particles (matte agent) made from a resin or an inorganic compound in addition to a binder containing a resin compound, for the purpose of imparting anti-glare properties by forming the surface unevenness. The fine particles have an average particle size preferably of 1.0 to 10.0 μm, and further preferably of 1.5 to 5.0 μm. In addition, particle sizes smaller than the film thickness of the binder in the anti-glare layer are preferably less than 50% of those of the total fine particles. A particle size distribution can be measured by a Coulter counter method, but is considered after having been converted into a particle number distribution. The film thickness of the anti-glare layer is preferably 0.5 to 10 μm, and further preferably is 1 to 5 μm.

A material used for forming the above described hard coat layer is preferably used for a resin binder for forming the anti-glare layer, because the material gives the film strength and transparency. When the anti-glare layer is used in combination with the anti-reflection layer, it may improve anti-reflection properties of the anti-reflection layer by concomitantly using the above described hard coat material with a monomer having a high refractive index or an inorganic particle having a high refractive index to increase the refractive index of the layer from 1.50 to 2.00. An example of the monomer having the high refractive index includes bis(4-methacryloyl thiophenyl) sulfide, vinylnaphthalene, vinylphenyl sulfide, and 4-methacryloxyphenyl-4′-methoxyphenyl thioether. An example of the inorganic particle having the high refractive index preferably includes a fine particle which is made from at least one oxide selected from among titanium, zirconium, aluminum, indium, zinc, tin and antimony, and has a particle size of 100 nm or smaller and preferably of 50 nm or smaller. An example of the fine particle includes TiO₂, ZrO₂, Al₂O₃, In₂O₃, ZnO, SnO₂, Sb₂O₃ and ITO. An amount of the inorganic particles to be added is preferably 10 to 90 mass % of the total weight of the hard coat layer, and further preferably is 20 to 80 mass %.

When imparting unevenness on the surface of a support by embossment, it is preferable to form the surface unevenness after having formed all the plurality of optical interference layers. If the plurality of optical interference layers are formed by a wet coating method after the surface unevenness has been formed, each layer forms the unevenness of the film thickness due to a pool of the coating liquid in a recess, and consequently causes the remarkable aggravation of anti-reflection performance, which is unpreferable. The film thickness of the optical interference layer is substantially uniformized by embossing the optical interference layers, after having formed all the layers. Here, “film thickness is substantially uniformized” means that the film thickness is within ±3% of the central film thickness.

On an antireflection film, a single layer with a low refractive index is provided so as to have a film thickness, a refractive index and a layer structure which are designed on the basis of a principle of light interference between optical thin films, or an anti-reflection layer composed of a plurality of low refractive index layers and high refractive index layers is provided. In the above description, the low refractive index layer and the high refractive index layer respectively mean the layer having a lower refractive index than that of a support and the layer having a higher refractive index than that of the support. Any of the layers has the film thickness of an optical wavelength order or less of a light which is an anti-reflective object. A layer having such an extremely thin film thickness is referred to as an optical thin film, and is practically used in various applications such as an anti-reflection film or a reflection film, for an optically functional layer based on the principle of the light interference.

The low refractive index layer and the high refractive index layer used in the anti-reflection layer preferably satisfy the following expressions (f1) and (f2) respectively.
mλ/4×0.7<n1d1<mλ/4×1.3 Expression (f1):
nλ/4×0.7<n2d2<nλ/4×1.3 Expression (f2):
wherein (m) is a positive odd number (1, in general); (n) is a positive integer; n1 and n2 are the refractive indices of a low refractive index layer and a high refractive index layer respectively; and d1 and d2 are the film thicknesses of the low refractive index layer and the high refractive index layer.

A material for the low refractive index layer can be selected from among materials having a refractive index of 1.30 to 1.49, as a material having the balance of film strength and refractive index. Specifically, a preferable example to be used is a low refractive index layer formed of particles with such a small particle sizes as not to cause the scattering of light having air gaps between the particles, which is disclosed in each bulletin of Japanese Patent Application Laid-Open No. H11-38202 and Japanese Patent Application Laid-Open No. H11-326601, and a fluorine-containing compound which is cross-linked by heat or ionizing radiation. A cross-linkable fluorine high-molecular compound includes a silane compound containing a perfluoroalkyl group (for instance, (heptadecafluoro-1,1,2,2-tetradecyl) triethoxysilane), and a fluorine-containing copolymer which contains a fluorine-containing monomer and a monomer for imparting cross-linkable properties as a structural unit.

Specific examples of a fluorine-containing monomer unit include: for instance, a fluoroolefin (for instance, fluoroethylene, vinylidene fluoride, tetrafluoroethylene, hexafluoro ethylene, hexafluoropropylene, perfluoro-2,2-dimethyl-1,3-dioxole); a partially or completely fluorinated alkyl ester derivative of (meth) acrylic acid (for instance, Biscoat 6FM (made by Osaka Organic Chemical Industry Ltd.), M-2020 (made by Daikin) or the like); and a partially or completely fluorinated vinyl ether.

A monomer for imparting a cross-linkable group includes a (meth)acrylate monomer having a cross-linkable functional group in the molecule such as glycidyl methacrylate; and a (meth)acrylate monomer having a carboxyl group, a hydroxyl group, an amino group, a sulfonate group and/or the like (for instance, (meth) acrylic acid, methylol (meth)acrylate, hydroxyalkyl (meth)acrylate, allyl acrylate and the like). It is disclosed in each of Japanese Patent Application Laid-Open No. H10-147739 and Japanese Patent Application Laid-Open No. H10-25388 that the latter compound can introduce a cross-linking structure therein after having been copolymerized.

Not only a polymer having the above described fluorine-containing monomer as a structural unit, but also a copolymer formed with a monomer containing no fluorine atom may be used. A concomitantly usable monomer unit is not limited in particular, and includes, for instance: an olefine (ethylene, propylene, isoprene, chloroethylene, vinylidene chloride and the like); an acrylic ester (methyl acrylate, ethyl acrylate and 2-ethylhexyl acrylate); a methacrylic ester (methyl methacrylate, ethyl methacrylate, butyl methacrylate, ethylene glycol dimethacrylate and the like); a styrene derivative (styrene, divinylbenzene, vinyltoluene, α-methyl styrene and the like); a vinyl ether (methyl vinyl ether and the like); a vinyl ester (vinyl acetate, vinyl propionate, vinyl cinnamate and the like); an acrylic amide (N-tertbutylacrylamide, N-cyclohexylacrylamide and the like); a methacrylamide; and an acrylonitrile derivative.

A material which is preferably used when forming the above described anti-glare layer having a high refractive index is similarly used in a high refractive index layer. A preferred refractive index is in a range between 1.70 and 2.20, a preferred film thickness is in a range between 5 and 300 nm. The refractive index and the film thickness shall be designed according to the above described expression (f2).

Each layer of a hard coat layer, an anti-glare layer and an anti-reflection layer can be formed by applying a coating liquid with a dip coating method, an air knife coating method, a curtain coating method, a roll coating method, a wire bar coating method, a gravure coating method, a microgravure method and an extrusion coating method (U.S. Pat. No. 2,681,294). Two or more layers may be applied simultaneously. A simultaneous application method is described in each patent of U.S. Pat. No. 2,761,791, U.S. Pat. No. 2,941,898, U.S. Pat. No. 3,508,947 and U.S. Pat. No. 3,526,528, and “Coating Engineering” by Yuji Harazaki (published by Asakura Shoten in 1973) page 253.

Among them, Japanese Patent application Laid-Open No. 2003-149413 describes a light diffusion film which has a light diffusion layer containing translucent fine particles in a translucent resin, on a cellulose acetate film with an acetylation degree of 59.0 to 61.5%, in order to provide a liquid crystal display device that seldom causes the degradation of the contrast, the change of gradation or black-and-white inversion and the change of the hue due to the change of the angle, and has superior display quality. The cellulose acetate film has a thickness of 20 to 70 μm, a cutoff value of 0.8 mm per length of 100 mm and an arithmetic mean surface roughness Ra of 0.2 μm or less. The cellulose acetate film according to the invention can be also applied to the present invention.

An anti-glare film and an antireflection film according to the present invention can be directly affixed to one surface or both surfaces of a polarizer, and is used for a protective film of a polarizer, in a process of producing a polarizing plate to be used in each application mainly including an LCD, after having saponified a back face of a support by some means, before or after forming an anti-glare layer and an anti-reflection layer.

When a retardation film is arranged between a cell containing a sealed-in liquid crystal and the polarizing plate for widening a visual field of the LCD in particular, the anti-glare film or the antireflection film can be affixed to the air interface side of the polarizing plate to be used in a watching side, among polarizing plates arranged in both sides of the cell, as the protective film; and the retardation film can be affixed to the opposite face, specifically a face between the cell and the polarizer. Thus, those films can be used for both faces of the polarizer as the protective layer. The polarizing plate with such a structure can acquire functions such as a wide view angle and low reflectivity though the thickness is equal to that of a conventional polarizing plate, and is extremely preferable for a high-function LCD.

A multilayer film formed of stacked transparent thin films of inorganic compounds (metallic oxides) having different refractive indices is formed by: a chemical vapor deposition (CVD) method; a physical vapor deposition (PVD) method; and a method of forming a thin film of colloidal metal oxide particles by using a sol gel technique for a metallic compound such as a metalalkoxide, and post-treating the thin film (ultraviolet irradiation: Japanese Patent Application Laid-Open No. H09-157855, or plasma treatment: Japanese Patent Laid-Open No. 2002-327310). On the other hand, various anti-reflection films produced by stacking a thin film having inorganic particles dispersed in a matrix with a coating method are proposed as the anti-reflection film that can be produced with high productivity.

There is an antireflection film formed of an anti-reflection layer which has fine unevenness formed on an antireflection film prepared by the above described coating method and has thereby imparted anti-glare properties.

[Layer Structure of Coat-Type Antireflection Film]

An anti-reflection film with a layer structure comprising at least a middle refractive index layer, a high refractive index layer and a low refractive index layer (outermost layer) formed on a substrate in this order is designed so as to acquire such a refractive index as to satisfy the following relationship: refractive index of high refractive index layer>refractive index of middle refractive index layer>refractive index of transparent support>refractive index of low refractive index layer. In addition, a hard coat layer may be provided in between the transparent support and the middle refractive index layer. Furthermore, the anti-reflection film may be formed of the middle refractive index hard coat layer, the high refractive index layer and the low refractive index layer. The anti-reflection film is described in, for instance, Japanese Patent Application Laid-Open No. H08-122504, Japanese Patent Application Laid-Open No. H08-110401, Japanese Patent Application Laid-Open No. H10-300902, Japanese Patent Laid-Open No. 2002-243906, and Japanese Patent Laid-Open No. 2000-111706. In addition, other functions may be imparted to each layer. For instance, there are a low refractive index layer to which anti-fouling properties are imparted, and a high refractive index layer to which antistatic properties are imparted (Japanese Patent Application Laid-Open No. H10-206603 and Japanese Patent Laid-Open No. 2002-243906). The anti-reflection film has a haze preferably of 5% or less, and further preferably of 3% or less. The anti-reflection film also has the strength preferably of H or higher by a pencil hardness test according to JIS K5400, further preferably of 2 H or higher, and most preferably of 3 H or higher.

An anti-glare anti-reflection film with a layer structure having the anti-glare layer and the low refractive index layer stacked on a substrate is designed so as to acquire such a refractive index as to satisfy the following expression: refractive index of anti-glare layer>refractive index of low refractive index layer. In addition, the anti-glare anti-reflection film may also have a hard coat layer provided between the transparent support and the anti-glare layer. The anti-reflection film preferably has a haze fitting to that of the anti-glare layer. The anti-glare anti-reflection film also has the strength preferably of H or higher by a pencil hardness test according to JIS K5400, further preferably of 2 H or higher, and most preferably of 3 H or higher.

A clear-type anti-reflection film with a layer structure having the hard coat layer on a substrate and the low refractive index layer stacked thereon is designed so as to acquire such a refractive index as to satisfy the following expression: refractive index of anti-glare layer>refractive index of low refractive index layer. In addition, the clear-type anti-reflection film may also have the hard coat layer provided between the transparent support and the anti-glare layer. The anti-reflection film has a haze preferably of 5% or less, and further preferably of 3% or less. The clear-type anti-reflection film also has the strength preferably of H or higher by the pencil hardness test according to JIS K5400, further preferably of 2 H or higher, and most preferably of 3 H or higher.

An anti-glare anti-reflection film with a layer structure having the anti-glare layer formed on a substrate and the high refractive index layer and the low refractive index layer stacked thereon is designed so as to acquire such a refractive index as to satisfy the following expression: refractive index of high refractive index layer>refractive index of transparent support>refractive index of low refractive index layer. The anti-reflection film preferably has a haze fitting to that of the anti-glare layer. The anti-glare anti-reflection film also has the strength preferably of H or higher by the pencil hardness test according to JIS K5400, further preferably of 2 H or higher, and most preferably of 3 H or higher.

An anti-glare anti-reflection film with a layer structure having the hard coat layer formed on a substrate and the high refractive index layer and the low refractive index layer stacked thereon is designed so as to acquire such a refractive index as to satisfy the following expression: refractive index of high refractive index layer>refractive index of transparent support>refractive index of low refractive index layer. The anti-reflection film has a haze preferably of 5% or less, and further preferably of 3% or less. The anti-glare anti-reflection film also has the strength preferably of H or higher by the pencil hardness test according to JIS K5400, further preferably of 2 H or higher, and most preferably of 3 H or higher.

(Transparent Support to be Used for Antireflection Film)

A transparent support has an optical transmittance of preferably 80% or higher and further preferably 86% or higher. The transparent support has a haze of preferably 2.0% or less and further preferably 1.0% or less. The transparent support has a refractive index of preferably 1.4 to 1.7. In addition, it is preferable to use a plastic film. Examples of a material of a plastic film include cellulose ester, a polyamide, polycarbonate, a polyester (for instance, polyethyleneterephthalate, polyethylenenaphthalate), polystyrene, a polyolefin, a polysulfone, a polyethersulfone, a polyarylate, a polyetherimide, polymethyl methacrylate and a polyether ketone.

(High Refractive Index Layer and Middle Refractive Index Layer)

A layer having a high refractive index of an anti-reflection film is formed of a curable film which contains at least an ultra-fine particle of an inorganic compound having an average particle size of 100 nm or smaller and a high refractive index, and a matrix binder. The fine particle of the inorganic compound having the high refractive index includes an inorganic compound having a refractive index of 1.65 or higher, and preferably a refractive index of 1.7 or higher. The inorganic compound includes, for instance: an oxide such as Ti, Zn, Sb, Sn, Zr, Ce, Ta, La and In; and a composite oxide containing these metal atoms. A technology for producing ultrafine particles of the inorganic compound includes: a method of treating the surface of the particle with a surface treatment agent (for instance, a silane coupling agent or the like: Japanese Patent Application Laid-Open No. H11-295503, Japanese Patent Application Laid-Open No. H11-153703 and Japanese Patent Laid-Open No. 2000-9908, an anionic compound or an organic metal coupling agent: Japanese Patent Laid-Open No. 2001-310432); a method of forming a core shell structure while using the particle having the high refractive index as a core (Japanese Patent Laid-Open No. 2001-166104); and concomitantly using a particular dispersing agent (for instance, Japanese Patent Application Laid-Open No. H11-153703, U.S. Pat. No. 6,210,858B1 and Japanese Patent Application Laid-Open No. 2002-2776069). A material for forming a matrix includes a conventionally well-known thermoplastic resin and a curable resin film. Furthermore, the material is preferably at least one composition selected from the group consisting of: a polyfunctional compound containing at least two or more radical-polymerizable and/or cation-polymerizable groups; an organometallic compound containing a hydrolysable group; and a partially condensed composition thereof. The examples include a compound described in Japanese Patent Application Laid-Open No. 2000-47004, Japanese Patent Application Laid-Open No. 2001-315242, Japanese Patent Application Laid-Open No. 2001-31871, and Japanese Patent Application Laid-Open No. 2001-296401. The preferable material also includes a curable film obtained from a colloidal metal oxide prepared from a hydrolysis condensation product of a metalalkoxide, and a metalalkoxide composition. The film is described in Japanese Patent Application Laid-Open No. 2001-293818, for instance. The high refractive index layer has a refractive index of 1.70 to 2.20, in general. The high refractive index layer has a thickness of preferably 5 nm to 10 μm and further preferably 10 nm to 1 μm. The refractive index of the middle refractive index layer is adjusted so as to be a value between the refractive index of a low refractive index layer and the refractive index of the high refractive index layer. The refractive index of the middle refractive index layer is preferably 1.50 to 1.70.

(Low Refractive Index Layer)

A low refractive index layer is formed by being sequentially stacked on a high refractive index layer. The low refractive index layer has a refractive index of 1.20 to 1.55 and preferably of 1.30 to 1.50. The low refractive index layer is preferably formed to be the outermost layer having excoriation resistance and anti-fouling properties. It is an effective technique for greatly improving the excoriation resistance to impart smoothness to the surface. An applicable technique is to form a conventionally well-known thin layer into which silicone and/or fluorine is introduced. The refractive index of a fluorine-containing compound is preferably 1.35 to 1.50, and further preferably is 1.36 to 1.47. The fluorine-containing compound also preferably includes a cross-linkable or polymerizable functional group containing 35 to 80 mass % of fluorine atoms. Examples of the compound include the compounds described in paragraph number [0018] to [0026] of Japanese Patent Application Laid-Open No. H09-222503, paragraph number [0019] to [0030] of Japanese Patent Application Laid-Open No. H11-38202, paragraph number [0027] to [0028] of Japanese Patent Application Laid-Open No. 2001-40284, Japanese Patent Application Laid-Open No. 2000-284102 and the like. The silicone compound is preferably a compound which has a poly siloxane structure, contains a curable functional group or a polymerizable functional group in the polymer chain and forms a cross-linking structure in the film. The examples of the silicone compound include a reactive silicone (for instance, Silaplane (made by Chisso Corporation)), and poly siloxane containing a silanol group in both terminals (Japanese Patent Application Laid-Open No. H11-258403 and the like). It is preferable to make a polymer containing fluorine and/or siloxane and having a cross-linkable or polymerizable group cause a cross-linking or polymerization reaction, simultaneously when or after a coating composition for forming the outermost layer containing a polymerization initiator, a sensitizer and the like has been coated thereon, by irradiating the coated composition with light or by heating the coated composition. A sol-gel curable film is also preferable which cures through a condensation reaction occurring in between an organometallic compound and a particular silane coupling agent containing a hydrocarbon group containing fluorine, in the coexistence of a catalyst. Examples of the compound include: a silane compound containing a polyfluoroalkyl group or a partial hydrolysis condensate thereof (compound described in Japanese Patent Application Laid-Open No. S58-142958, Japanese Patent Application Laid-Open No. S58-147483, Japanese Patent Application Laid-Open No. S58-147484, Japanese Patent Application Laid-Open No. H09-157582 and Japanese Patent Application Laid-Open No. H11-106704); and a silyl compound containing a poly (perfluoro alkylether) group which is a fluorine-containing long-chain group (compound described in Japanese Patent Application Laid-Open No. 2000-117902, Japanese Patent Application Laid-Open No. 2001-48590 and Japanese Patent Application Laid-Open No. 2002-53804).

The low refractive index layer can include a filler (for instance, a low refractive index inorganic compound with an average size of primary particles of 1 to 150 μm, such as silicon dioxide (silica) and a fluorine-containing particle (magnesium fluoride, calcium fluoride and barium fluoride), an organic particle described in paragraph number [0020] to [0038] of Japanese Patent Application Laid-Open No. H11-3820 and the like), a silane coupling agent, a smoothing agent and a surface active agent, except the above described additive. When the low refractive index layer is located at the outermost layer, the low refractive index layer may be formed with a gas phase method (such as vacuum deposition method, sputtering method, ion plating method and plasma CVD method). A coating method is preferable because the production cost is inexpensive. The film thickness of the low refractive index layer is preferably 30 to 200 nm, further preferably is 50 to 150 nm, and most preferably is 60 to 120 nm.

(Other Layer than Antireflection Film)

The antireflection film may be further provided with a hard coat layer, a forward scattering layer, a primer layer, an antistatic layer, an undercoating layer, a protective layer and the like.

(Hard Coat Layer)

A hard coat layer is provided on a transparent support so as to impart physical strength to the antireflection film. The hard coat layer is preferably provided particularly between the transparent support and the above described high refractive index layer. The hard coat layer is preferably formed by a cross-linking reaction or polymerization reaction of a curable compound by light and/or heat. The curable functional group preferably is a photopolymerizable functional group. In addition an organometallic compound containing a hydrolyzable functional group preferably is an organic alkoxysilyl compound.

Specific examples of the compounds include the same compound as in a description on the high refractive index layer. Specific compositions of the hard coat layer are described in Japanese Patent Laid-Open No. 2002-144913, Japanese Patent Laid-Open No. 2000-9908, and WO No. 0/46617.

The high refractive index layer can serve as the hard coat layer as well. In such a case, it is preferable to form the hard coat layer which contains fine particles dispersed therein by using the technique described in the high refractive index layer. The hard coat layer can serve as an anti-glare layer (described below) having an anti-glare function imparted by containing particles with an average particle size of 0.2 to 10 μm. The film thickness of the hard coat layer can be adequately designed according to a field of application. The film thickness of the hard coat layer is preferably 0.2 to 10 μm, and further preferably is 0.5 to 7 μm. The hard coat layer has a strength preferably of H or higher by a pencil hardness test according to JIS K5400, further preferably of 2 H or higher, and most preferably of 3 H or higher. The hard coat layer also preferably shows abrasion loss as little as possible, in test pieces before and after the test according to a taper test specified in JIS K5400.

(Forward Scattering Layer)

A forward scattering layer is provided on the antireflection film so that when the antireflection film has been applied to a liquid crystal display, the antireflection film can impart a view-angle-improving effect to the liquid crystal display when a visual angle is changed to various directions. When the forward scattering layer is formed by dispersing fine particles with different refractive indices in the above described hard coat layer, the forward scattering layer can show a hard coat function as well. The examples are described in Japanese Patent Laid-Open No. H11-38208 in which a forward scattering coefficient is specified, Japanese Patent Laid-Open No. 2000-199809 in which relative refractive indices of a transparent resin and fine particles are specified into a particular range, and Japanese Patent Laid-Open No. 2002-107512 in which a haze value is specified into 40% or more.

(Antiglare Function)

An anti-reflection film may have an anti-glare function for scattering extraneous light. The anti-glare function is imparted to the anti-reflection film by forming unevenness on the surface of the anti-reflection film. When the anti-reflection film has the anti-glare function, a haze of the anti-reflection film is preferably 3 to 30%, further preferably is 5 to 20%, and most preferably is 7 to 20%. The method of forming the unevenness on the surface of the anti-reflection film can employ any method, as long as the method can sufficiently keep the surface shape. The examples include: a method of forming the unevenness on the film surface by dispersing fine particles in a low refractive index layer (for instance, Japanese Patent Application Laid-Open No. 2000-271878); a method of adding a small amount (0.1 to 50 mass %) of comparatively large particles (particle size of 0.05 to 2 μm) into an underlayer (high refractive index layer, middle refractive index layer or hard coat layer) of the low refractive index layer to form the film having the unevenness on the surface, and forming the low refractive index layer thereon so that the surface can keep the shape of the underlayer (for instance, Japanese Patent Application Laid-Open No. 2000-281410, Japanese Patent Application Laid-Open No. 2000-95893, Japanese Patent Application Laid-Open No. 2001-100004 and Japanese Patent Application Laid-Open No. 2001-281407); and a method of transferring the shape of the unevenness physically onto the surface of the coated outermost layer (antifouling layer) (for example of embossing method, Japanese Patent Application Laid-Open No. S63-278839, Japanese Patent Application Laid-Open No. H11-183710 and Japanese Patent Application Laid-Open No. 2000-275401).

An example of a method for producing an anti-reflection film will now be described below.

An apparatus pays off a web of a transparent support. A guide roller guides the web and sends it to a dust collector. The dust collector can remove dust depositing on the surface of the web (W). An application head of an extrusion-type applicator of an application device is installed in the downstream of the dust collector so as to be capable of applying a coating liquid to the web wound around a back-up roll. Other usable application methods includes a dip coating method, an air knife coating method, a curtain coating method, a slide coating method, a roll coating method, a wire bar coating method, a gravure coating method and a microgravure method. The application head should be arranged in a clean atmosphere such as in a clean room. In this case, the cleanliness factor is preferably a class of 1,000 or less, more preferably a class of 100 or less, and further preferably is a class of 10 or less.

The application unit sequentially or simultaneously applies coating liquids for an anti-glare layer and an anti-reflection layer onto a support (including a support that has been already provided with some functional layers). An (initial) drying zone and a heating (main drying) zone are sequentially installed in the downstream of the application head. It is preferable to vaporize a solvent in the (initial) drying zone while controlling the evaporation of the solvent by sealing the surface of the formed coating layer (coating film) with a gas layer, and to further dry the coating layer in the heating (main drying) zone after most of the solvent has evaporated. It is preferable to move the gas layer for sealing the surface of the coating layer in the drying zone, at a relative speed of −0.1 to 0.1 nm/sec with respect to the traveling speed of the coating layer, along the surface of the coating layer. It is preferable to vaporize the above described solvent while controlling the evaporation, within a period in which the solvent content in the coating layer decreases in proportion to a drying period of time. The drying zone preferably has a cover. A straightened air or uniform air may be used as drying air. The evaporated solvent may be removed by making a cold condensation plate installed so as to face the surface of the coating film to condense the solvent. An ultraviolet lamp, for instance, is prepared for a step of curing the coating film in the downstream of a drying step. The ultraviolet lamp irradiates the coating film with ultraviolet rays to desirably cure the film and cross-link the resin. In addition, a heat treatment zone for curing the film by heat can be arranged though it depends on a material, in which the film is desirably cured and the resin is cross-linked. Alternatively, the web may be wound up, and then be heated in an oven in another step, or may be transported to a furnace and then be heat-treated therein. Afterward, a winding machine installed in the downstream winds up the web having an anti-reflection film formed thereon.

When sequentially applying coating liquids for forming two or more layers on a substrate or a film, it is preferable to continuously apply the liquids (to repeat the application and drying steps without winding the web, and then finally wind the web), because the method is productive.

### EXAMPLES

Examples of drying a coating film containing an organic solvent according to the present invention will be described below with reference to an example of an optical compensation sheet.

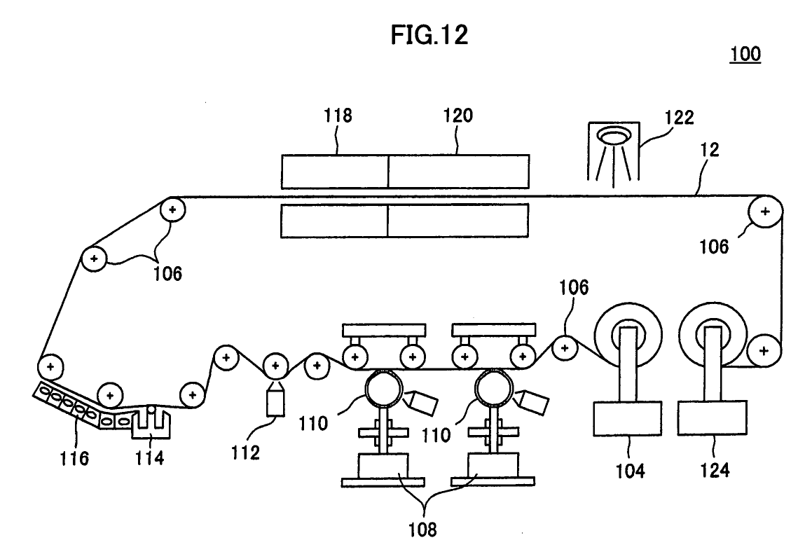

At first, an outline of a process for producing the optical compensation sheet will now be described. FIG. 12 is an explanatory view for describing the process of producing the optical compensation sheet to which a method for drying a coating liquid according to the present invention is applied. Incidentally, the figure describes the process with reference to the example of employing a drying apparatus 16 described in the first embodiment.

As shown in FIG. 12, a pay-off machine 104 pays off a web 12 which is a transparent support having a polymer layer for forming an orientational film formed thereon, and sends the web 12 to a rubbing treatment device 108 while a plurality of guide rollers 106 support the web 12. A rubbing roller 110 is installed for rubbing-treating the polymer layer. A dust collector 112 is installed in the downstream of the rubbing roller 110, and removes dust depositing on the surface of the web 12. An applicator 114 is installed in the downstream of the dust collector 112, and applies a coating liquid containing a disco-nematic liquid crystal onto the web 12.

The web 12 having the above described coating liquid coated thereon passes through an initial drying zone 116 to which a drying method according to the present invention is applied, and then is dried in a main drying zone 118 and a heating zone 120. An ultraviolet lamp 122 is installed in the downstream, and irradiates the dried film with ultraviolet rays to cross-link the liquid crystal and form a desired polymer. A winding machine 124 is installed in the downstream, and winds up the web 12 having the polymer formed thereon.

In the step of producing the optical compensation sheet shown in FIG. 12, an air velocity (air-supplying velocity and air-exhausting velocity) of drying air in the respective divided zones in the initial drying zone 116 was varied as is shown in Table 1, which correspond to respective divided zones 26A to 26G in FIG. 3. A state of the unevenness of drying in thus produced optical compensation sheets was visually inspected.

The surface state was evaluated into the following four levels: excellent; no visible unevenness of drying, good; almost no visible unevenness of drying, fair; slightly visible unevenness of drying, and poor; clearly visible unevenness of drying. In the above description, “good” means that the optical compensation sheet has a sufficiently uniform surface as a product.

In the present example, a web 12 employed a sheet formed of triacetylcellulose with a thickness of 100 μm (Fujitac made by Fuji Photo Film Co., Ltd.). The web 12 having a resin layer for an orientational film formed thereon was prepared by the steps of: applying a 2 mass % solution of a long-chain-alkyl-modified poval (MP-203 made by Kuraray Co., Ltd.) on the surface of the web 12 so that the applied amount could be 25 mL per square meter of the web; and drying the applied solution at 60° C. for one minute. Then, the orientational film was formed on the web 12 by the step of rubbing-treating the resin layer with a rubbing treatment device 108 while paying off the web 12 with a pay-off machine 104. An applied pressure of a rubbing roller 110 during rubbing treatment was set at 98 Pa (10 kgf/cm²) per square centimeter of the resin layer of the orientational film, and a peripheral speed of the rotating roller 110 was set at 5.0 m/second.

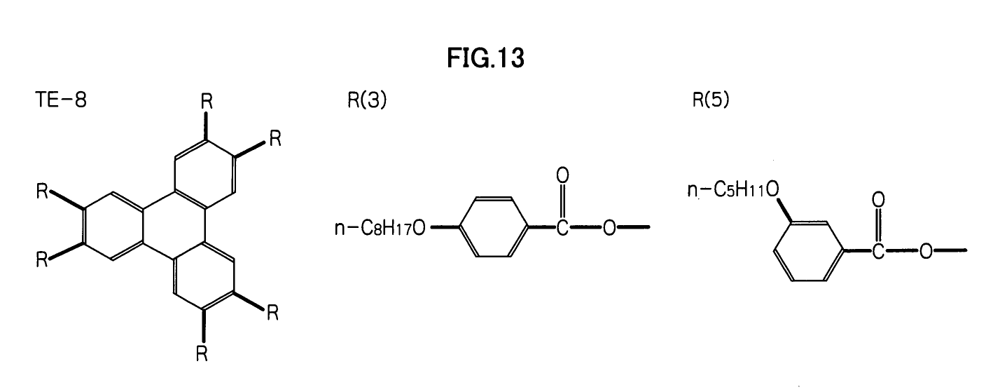

Subsequently, a coating liquid was applied on the orientational film which has been obtained by rubbing-treating the resin layer for the orientional film. The used coating liquid was a methyl ethyl ketone solution that includes 40 mass % of a mixture which comprises: a mixture containing discotic compounds TE-8 (3) and TE-8 (5) (see FIG. 13) of a liquid crystalline compound at a weight ratio of 4:1; and a photoinitiator (Irgacure 907, made by Ciba Geigy Japan Co., Ltd.) added in an amount of 1 wt % with respect to the above described mixture.

The coating liquid was applied onto the orientational film with a wire bar 14A so that the amount of the coating liquid could be 5 μm by wet thickness per square meter of the web, while a web 12 is traveling at a traveling speed of 18 m/minute. Then, the web 12 was dried with the use of a drying apparatus 16 right after the coating liquid has been applied.

In the present example, the drying zones in FIG. 2 were divided into seven zones in such a way that a zone 1 corresponded to a divided zone 26A, a zone 2 to a divided zone 26B, a zone 3 to a divided zone 26C, a zone 4 to a divided zone 26D, a zone 5 to a divided zone 26E, a zone 6 to a divided zone 26F, and a zone 7 to a divided zone 26G. The air velocities in the zones 1 to 4 were set at 1 m/second, the air velocities in the zones 5 and 6 at 0.3 m/second, the air velocity in the zone 7 at 0.1 nm/second, and the air velocities in all the seven zones of the second drying zone at 0.1 m/second.

Subsequently, a nematic phase was formed on a web 12 by the step of passing the web 12 through a main drying zone 118 adjusted to 100° C. and a heating zone 120 adjusted to 130° C. After that, the surface of the liquid crystal layer was irradiated with ultraviolet rays through an ultraviolet lamp 122, while the web 12 having an orientational film and a liquid crystalline compound is continuously transported.

### Example A

In the present example, a drying apparatus 16 in FIG. 5 was employed, and the position of a supply opening 33 with respect to a web 12 was varied. Then, it was examined whether the dried web forms the unevenness of drying or not. Specifically, in the present example, a clearance (Y) was varied which is a distance between the web and an upper side inner wall surface among inner wall surfaces of air-supplying nozzles 34A to 34G, and in which a Y1 direction (upward) perpendicular to the surface of a coating film is determined to be a positive direction, and a Y2 direction (downward) is determined to be a negative direction.

It is noted that a diameter d of the supply opening 33 in Y1-Y2 direction is 30 mm and a height D of the drying zone 26 in Y1-Y2 direction is 75 mm.

TABLE 1

| | Clearance (Y) | | |
|---|---|---|---|
| | (mm) from inner | Air velocity (m/sec) | |
| | wall surface | in zones 1 to 4 | Surface state |
| Example 1 | −5 | 1.0 | Good |
| Example 2 | −10 | 1.0 | Good |
| Example 3 | −15 | 1.0 | Excellent |
| Example 4 | −15 | 1.5 | Excellent |
| Example 5 | −15 | 3.0 | Fair |
| Example 6 | 5 | 1.0 | Fair |
| Example 7 | 15 | 1.0 | Fair |
| Comparative | 0 | 1.0 | Poor |
| Example 1 | | | |
| Comparative | −30 | 1.0 | Poor |
| Example 2 | | | |

As shown in Table 1, when the surface of a coating film on a web 12 is positioned more distant from upper and lower inner wall surfaces of air-supplying nozzles 34A to 34G by a predetermined clearance (Y) or longer (5 mm to 15 mm), the produced samples showed almost no unevenness of drying and showed an adequate surface state (Examples 1 to 7). Particularly when the web 12 was positioned in a range of a width of a supply opening 33, the produced samples showed no unevenness of drying (Examples 1 to 4), and showed a better surface state than those produced when the web 12 was positioned outside the range of the supply opening 33 (Examples 6 to 7).

In contrast, when the surface of the coating film on the web 12 is positioned almost in the same plane as the upper or lower inner surface of the air-supplying nozzles 34A to 34G, the produced samples clearly showed the unevenness of drying

### Comparative Example 1 to 2

It was elucidated to be possible from the above results to reduce the unevenness of drying due to a turbulent airflow of a boundary layer generated on the inner wall surfaces of the air-supplying nozzles 34A to 34G by arranging the surface of the coating film of the web 12 at a position distant from the upper and lower inner wall surfaces of the air-supplying nozzles 34A to 34G by a predetermined clearance (Y) or longer (5 mm to 15 mm).

### Example B

Next, optical compensation sheets were prepared by using a drying apparatus 70 shown in FIG. 7, and the unevenness of drying produced on the sheets was visually inspected, as in the case of Example (A).

The used drying apparatus 72 had four air-supplying nozzles 90 arranged in an upstream in a drying zone 80, and an exhaust portion 84 arranged in the downstream. A clearance between the surface of the coating film on a web 12 and a supply opening 90A was set at 20 mm. The size of the supply opening 90A was set at 1,000 mm×50 mm. In addition, a pair of suction chambers 62 having a section size of 1,000×20 mm (depth (d): 25 mm) was provided in the perimeter of the supply opening 90A (see FIG. 8).

Samples were prepared by varying a ratio (suction rate) of a supplied amount to a sucked amount of drying air per one air-supplying nozzle 90 as is shown in Table 2, and it was examined whether the samples show the unevenness of drying or not.

TABLE 2

| | Supplied | Sucked | | Linear | |
|---|---|---|---|---|---|
| | air | air | | velocity | |
| | volume | volume | Suction | (m/minute) | |
| | (m³/ | (m³/ | rate | at supply | Surface |
| | minute) | minute) | (%) | opening | state |
| Example 1 | 6.0 | 0.3 | 5.0 | 0.9 | Good |
| Example 2 | 6.0 | 0.6 | 10.0 | 0.9 | Good |
| Example 3 | 6.0 | 1.2 | 20.0 | 0.8 | Good |
| Example 4 | 6.0 | 1.5 | 25.0 | 0.7 | Fair |
| Example 5 | 6.0 | 1.8 | 30.0 | 0.7 | Fair |
| Example 6 | 6.0 | 0.2 | 3.3 | 1.0 | Fair |
| Example 7 | 6.0 | 0.1 | 1.7 | 1.0 | Fair |
| Comparative | 6.0 | None | — | 1.0 | Poor |
| Example 1 | | | | | |
| Comparative | 5.4 | None | — | 0.9 | Poor |
| Example 2 | | | | | |
| Comparative | 3.0 | None | — | 0.5 | Poor |
| Example 3 | | | | | |

As is shown in Table 2, Examples 1 to 7 were dried at a supply opening 90A around which a turbulent airflow of a boundary layer was sucked. As a result, the Examples showed no unevenness of drying and showed an adequate surface state. On the other hand, Comparative examples 1 to 3 were dried at the supply opening 90A around which the turbulent airflow of the boundary layer was not sucked. Then, any of the Comparative examples showed the unevenness of drying. It was elucidated from the result that the unevenness of drying can be reduced when the turbulent airflow in the boundary layer is sucked and removed, and stable drying air is supplied.

In addition, when a suction rate was as too little as less than 5%, an effect of removing the turbulent airflow of the boundary layer was small. On the other hand, when the suction rate was increased, air supply efficiency decreased, and the number of necessary blowers increased to increase a running cost. Moreover, when the suction rate exceeded 20%, the turbulent airflow tended to appear on the surface of the coating film, on the contrary. Accordingly, it was elucidated that the unevenness of drying can be remarkably reduced by controlling the suction rate into a range of 5 to 20%.

From the results, it was confirmed to be possible to obtain an optical compensation sheet having no unevenness of drying and an adequate surface state, by applying a method of drying a coating film according to the present invention to the production of the optical compensation sheet.

What is claimed is:

1. A method for drying a coating film that has been formed by applying a coating liquid to a travelling long support,
by forming a tunnel-shaped drying zone so as to surround the support, and supplying drying air into the drying zone from a rectangular air-supplying nozzle which faces to the drying zone, wherein
the air-supplying nozzle is designed so that among layer components of the drying air which is supplied from the air-supplying nozzle, a boundary layer component which has flowed in the vicinity of the inner wall surface of the air-supplying nozzle and is supplied from the nozzle cannot hit the surface of the coating film, while there are the boundary layer component and a central layer component which has flowed in a central part of the air-supplying nozzle and is supplied from the nozzle, in the layer components.

2. The method for drying the coating film according to claim 1, wherein the boundary layer component is a drying air component having an air velocity of 66% or less with respect to the air velocity in a center of the air-supplying nozzle.

3. The method for drying the coating film according to claim 1, wherein
an upper inner wall surface and a lower inner wall surface of the air-supplying nozzle are installed so that clearances (Y) between the upper inner wall surface and the surface of the coating film and between the lower inner wall surface and the surface of the coating film can be each 5 mm or more in a vertical direction with respect to the surface of the coating film, for the purpose of inhibiting the boundary layer component from hitting the surface of the coating film, when the air-supplying nozzles are arranged in one side of the support in a width direction so as to blow the drying air from the air-supplying nozzle in parallel to the surface of the coating film.

4. The method for drying the coating film according to claim 2, wherein
an upper inner wall surface and a lower inner wall surface of the air-supplying nozzle are installed so that clearances (Y) between the upper inner wall surface and the surface of the coating film and between the lower inner wall surface and the surface of the coating film can be each 5 mm or more in a vertical direction with respect to the surface of the coating film, for the purpose of inhibiting the boundary layer component from hitting the surface of the coating film, when the air-supplying nozzles are arranged in one side of the support in a width direction so as to blow the drying air from the air-supplying nozzle in parallel to the surface of the coating film.

5. The method for drying the coating film according to claim 3, wherein a clearance X1 between the air-supplying nozzle and an end of the support in an air-supplying nozzle side in a width direction is 50 mm or more.

6. The method for drying the coating film according to claim 4, wherein a clearance X1 between the air-supplying nozzle and an end of the support in an air-supplying nozzle side in a width direction is 50 mm or more.

7. The method for drying the coating film according to claim 1, wherein the boundary layer component flowing in the vicinity of the inner wall surface of the air-supplying nozzle is sucked and removed so as not to hit the surface of the coating film.

8. The method for drying the coating film according to claim 2, wherein the boundary layer component flowing in the vicinity of the inner wall surface of the air-supplying nozzle is sucked and removed so as not to hit the surface of the coating film.

9. The method for drying the coating film according to claim 7, wherein the amount of air to be sucked and removed from the boundary layer component is in a range of 5 to 20% with respect to the total amount of the air blown from the air-supplying nozzle.

10. The method for drying the coating film according to claim 8, wherein the amount of air to be sucked and removed from the boundary layer component is in a range of 5 to 20% with respect to the total amount of the air blown from the air-supplying nozzle.

11. An apparatus for drying a coating film that has been formed by applying a coating liquid to a travelling long support, comprising:
a tunnel-shaped drying zone surrounding the support;
an air-supplying nozzle for supplying drying air to one side of the support in a width direction from the other side in parallel to the surface of the coating film in the drying zone; and
a moving device which moves the air-supplying nozzle in a direction perpendicular to the surface of the coating film to change a relative position of the air-supplying nozzle with respect to the surface of the coating film.

12. An apparatus for drying a coating film that has been formed by applying a coating liquid to a travelling long support, comprising:
a drying zone which surrounds the support in a tunnel shape;
a rectangular air-supplying nozzle for supplying drying air into the drying zone; and
a suction device which is installed in the air-supplying nozzle, and sucks and removes the drying air that passes the vicinity of the inner wall surface of the air-supplying nozzle.

13. An optical film which has been produced with the method for drying the coating film according to claim 1.
